(19) United States
(12) Patent Application Publication
(10) Pub. No.: US 2025/0014323 A1
(43) Pub. Date: Jan. 9, 2025

(54) MACHINE LEARNING SYSTEM AND METHOD FOR OBJECT-SPECIFIC RECOGNITION

(71) Applicant: TECHINSIGHTS INC., Ottawa (CA)

(72) Inventors: Christopher PAWLOWICZ, Ottawa (CA); Michael GREEN, Nepean (CA); Bruno MACHADO TRINDADE, Kanata (CA); Sneha PULLELA, Ottawa (CA); Zifan YU, Tempe, AZ (US); Fengbo REN, Chandler, AZ (US)

(21) Appl. No.: 18/709,249

(22) PCT Filed: Nov. 14, 2022
(86) PCT No.: PCT/CA2022/051676

§ 371 Date: May 10, 2024

Related U.S. Application Data
(60) Provisional application No. 63/279,311, filed on Nov. 15, 2021.
(60) Provisional application No. 63/282,102, filed on Nov. 22, 2021.
(60) Provisional application No. 63/308,869, filed on Feb. 10, 2022.

(51) Int. Cl. G06V 10/82; G06V 10/26; G06V 10/774; G06V 20/69

(52) U.S. Cl. CPC G06V 10/82; G06V 10/26; G06V 10/774; G06V 20/69

(57) ABSTRACT

Described are various embodiments of a machine learning system and method for object-specific recognition.

### RELATED APPLICATIONS

This application claims benefit of priority to U.S. Provisional Patent Application No. 63/279,311 entitled ‘MACHINE LEARNING SYSTEM AND METHOD FOR OBJECT-SPECIFIC RECOGNITION’, filed Nov. 15, 2021, U.S. Provisional Patent Application No. 63/282,102 entitled ‘MACHINE LEARNING SYSTEM AND METHOD FOR OBJECT-SPECIFIC RECOGNITION’, filed Nov. 22, 2021, and to U.S. Provisional Patent Application No. 63/308,869 entitled ‘MACHINE LEARNING SYSTEM AND METHOD FOR OBJECT-SPECIFIC RECOGNITION’, filed Feb. 10, 2022, entire disclosures of which are hereby incorporated by reference.

### FIELD OF THE DISCLOSURE

The present disclosure relates to machine learning, and, in particular, to a machine learning system and method for object-specific recognition.

### BACKGROUND

Semiconductor analysis is important for gaining insights on, for instance, technology competitiveness and intellectual property (IP) infringement. An important aspect of semiconductor analysis is the extraction of integrated circuit (IC) features (e.g. the segmentation of wires, the detection of vias, the recognition of diffusion or polysilicon features, or the like) from electron microscopy images. However, automatic extraction of such features is challenged by, among other aspects, low segmentation accuracy arising from noisy images, contamination, and intensity variation between circuit images. While some academic articles report a degree of success with respect to, for instance, image segmentation, such disclosures often relate to quasi-ideal images. The image acquisition speeds required for industrial applications, however, lead to images with increased noise, resulting in processing errors that may be very time consuming, and/or require significant human intervention, to correct.

Existing circuit segmentation processes are highly dependent on hand-tuned parameters to achieve reasonable results. For example, Wilson, et al. (Ronald Wilson, Navid Asadizanjani, Domenic Forte, and Damon L. Woodard, ‘Histogram-based Auto Segmentation: A Novel Approach to Segmenting Integrated Circuit Structures from SEM Images’, arXiv: 2004.13874, 2020) proposed an intensity histogram-based method to automatically segment integrated circuits. However, there is no quantitative analysis of performance in this report with respect to different integrated circuit images having significant intensity variation. Moreover, while focus is placed on wire segmentation, there is lacking adequate extraction of information with respect to vias, such as accurate via location data, which is an important aspect of many semiconductor analysis applications. Similarly, Trindade, et al. (Bruno Machado Trindade, Eranga Ukwatta, Mike Spence, and Chris Pawlowicz, ‘Segmentation of Integrated Circuit Layouts from Scanning Electron Microscopy Images’, 2018 IEEE Canadian Conference on Electrical Computer Engineering (CCECE), 1-4, DOI: 10.1109/CCECE.2018.8447878, 2018) explores the impacts of different pre-processing filters on scanning electron microscopy (SEM) images, and proposes a learning-free process for integrated circuit segmentation. However, again, the effectiveness of the proposed approach relies on a separation threshold, which may be challenging if not impossible to generically establish across images with a large variation in intensity or in circuit configurations.

Machine learning platforms offer a potential solution for improving the automation of image recognition. For example, Lin et al. (Lin, et al., ‘Deep Learning-Based Image Analysis Framework for Hardware Assurance of Digital Integrated Circuits’, 2020 IEEE International Symposium on the Physical and Failure Analysis of Integrated Circuits (IPFA), pp. 1-6, DOI: 10.1109/IPFA49335.2020.9261081, 2020) discloses a deep learning-based approach to recognising electrical components in images, wherein a fully convolutional network is used to perform segmentation with respect to both vias and metal lines of SEM images of ICs.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a machine learning system and method for object-specific recognition that overcome some of the drawbacks of known techniques, or at least, provides a useful alternative thereto. Some aspects of this disclosure provide examples of such systems and methods.

In accordance with one aspect, there is provided an image analysis method for recognising each of a plurality of object types in an image, the method to be executed by at least one digital data processor in communication with a digital data storage medium having the image stored thereon, the method comprising: accessing a digital representation of at least a portion of the image; by a first reusable recognition model associated with a first machine learning architecture, recognising objects of a first object type of the plurality of object types in the digital representation; by a second reusable recognition model associated with a second machine learning architecture, recognising objects of a second object type of the plurality of object types in the digital representation; and outputting respective first and second object datasets representative of objects of the first and second object types in the digital representation of the image.

In one embodiment, one or more of the first or second reusable recognition model comprises a segmentation model or an object detection model.

In one embodiment, the first reusable recognition model comprises a segmentation model and the second reusable recognition model comprises an object detection model.

In one embodiment, one or more of the first or second reusable recognition model comprises a user-tuned parameter-free recognition model.

In one embodiment, one or more of the first or second reusable recognition model comprises a generic recognition model.

In one embodiment, one or more of the first or second reusable recognition model comprises a convolutional neural network recognition model.

In one embodiment, the first object type and the second object type correspond to different object types.

In one embodiment, the method further comprises training one or more of the first or second reusable recognition model with context-specific training images or digital representations thereof.

In one embodiment, the digital representation comprises each of a plurality of image patches corresponding to respective regions of the image.

In one embodiment, the method further comprises defining the plurality of image patches.

In one embodiment, the images patches are defined to comprise partially overlapping patch regions.

In one embodiment, the method further comprises refining output of objects recognised in the overlapping regions.

In one embodiment, the refining comprises performing an object merging process.

In one embodiment, the plurality of image patches is differently defined for the recognising objects of a first object type and the recognising objects of a second object type.

In one embodiment, for at least some of the image patches, one or more of the recognising objects of the first object type or the recognising objects of the second object type is performed in parallel.

In one embodiment, the method further comprises post-processing at least some of the objects in accordance with a refinement process.

In one embodiment, the refinement process comprises a convolutional refinement process.

In one embodiment, the refinement process comprises a k-nearest neighbours (k-NN) refinement process.

In one embodiment, one or more of the first or second object dataset comprises one or more of an image segmentation output or an object location output.

In one embodiment, the method is automatically implemented by the at least one digital data processor.

In one embodiment, the image is representative of an integrated circuit (IC).

In one embodiment, one or more of the first or second object type comprises a wire, a via, a polysilicon area, a contact, or a diffusion area.

In one embodiment, the image comprises an electron microscopy image.

In one embodiment, the image is representative of a respective region of a substrate and the method further comprises repeating the method for each of a plurality of images representative of respective regions of the substrate.

In one embodiment, the method comprises combining the first and second object datasets into a combined dataset representative of the image.

In one embodiment, the method comprises digitally rendering an object-identifying image in accordance with one or more of the first and second object datasets.

In one embodiment, the method comprises independently training the first and second reusable recognition models.

In one embodiment, the method comprises training the first and second reusable recognition models with training images augmented with application-specific transformations.

In one embodiment, the application-specific transformations comprise one or more of an image reflection, rotation, shift, skew, pixel intensity adjustment, or noise addition.

In accordance with another aspect, there is provided an image analysis method for recognising each of a plurality of object types of interest in an image, the method to be executed by at least one digital data processor in communication with a digital data storage medium having the image stored thereon, the method comprising: accessing a digital representation of the image; for each object type of interest, recognising each object of interest in the digital representation by a corresponding reusable object recognition model associated with a corresponding respective machine learning architecture; and outputting respective object datasets representative of respective objects of interest corresponding to each object type of interest in the digital representation of the image.

In accordance with another aspect, there is provided a method for digitally refining a digital representation of a segmented image defined by a plurality of pixels each having corresponding pixel value, the method to be digitally executed by at least one digital data processor in communication with a digital data storage medium having the digital representation stored thereon, the method comprising: for each refinement pixel to be refined, calculating a characteristic pixel value corresponding to the pixel values of a designated number of neighbouring pixels; digitally comparing the characteristic pixel value with a designated threshold value; and upon the characteristic pixel value satisfying a comparison condition with respect to the designated threshold value, assigning a refined pixel value to the refinement pixel.

In one embodiment, the calculating a characteristic pixel value comprises performing a digital convolution process.

In one embodiment, the segmented image is representative of an integrated circuit.

In one embodiment, the digital representation corresponds to output of a machine learning-based image segmentation process.

In accordance with another aspect, there is provided an image analysis method for recognising each of a plurality of circuit feature types in an image of an integrated circuit (IC), the method to be executed by at least one digital data processor in communication with a digital data storage medium having the image stored thereon, the method comprising, for each designated feature type of the plurality of circuit feature types: digitally defining a feature type-specific digital representation of the image; by a reusable feature type-specific object recognition model associated with a corresponding machine learning architecture, recognising objects of the designated feature type in the type-specific digital representation; and digitally refining in accordance with a feature type-specific refinement process output from the feature type-specific object recognition process.

In accordance with another aspect, there is provided an image analysis system for recognising each of a plurality of object types in an image, the system comprising: at least one digital data processor in network communication with a digital data storage medium having the image stored thereon, the at least one digital data processor configured to execute machine-executable instructions to access a digital representation of at least a portion of the image, by a first reusable recognition model associated with a first machine learning architecture, recognise objects of a first object type of the plurality of object types in the digital representation, by a second reusable recognition model associated with a second machine learning architecture, recognise objects of a second object type of the plurality of object types in the digital representation, and output respective first and second object datasets representative of objects of the first and second object types in the digital representation of the image.

In one embodiment, one or more of the first or second reusable recognition model comprises a segmentation model or an object detection model.

In one embodiment, the first reusable recognition model comprises a segmentation model and the second reusable recognition model comprises an object detection model.

In one embodiment, one or more of the first or second reusable recognition model comprises a user-tuned parameter-free recognition model.

In one embodiment, one or more of the first or second reusable recognition model comprises a convolutional neural network recognition model.

In one embodiment, the system further comprises a non-transitory machine-readable storage medium having the first and second reusable recognition models stored thereon.

In one embodiment, the machine-executable instructions further comprise instructions to define each of a plurality of image patches corresponding to respective regions of the image.

In one embodiment, the images patches comprise partially overlapping patch regions.

In one embodiment, the machine-executable instructions further comprise instructions to refine output of objects recognised in the overlapping regions.

In one embodiment, the machine-executable instructions to refine output correspond to performing an object merging process.

In one embodiment, the plurality of image patches is differently defined for recognising objects of the first object type and recognising objects of the second object type.

In one embodiment, the machine-executable instructions further comprise instructions to post-process at least some of the objects in accordance with a refinement process.

In one embodiment, the refinement process comprises a convolutional refinement process.

In one embodiment, the refinement process comprises a k-nearest neighbours (k-NN) refinement process.

In one embodiment, one or more of the first or second object dataset comprises one or more of an image segmentation output or an object location output.

In one embodiment, the image is representative of an integrated circuit (IC).

In one embodiment, one or more of the first or second object type comprises a wire, a via, a polysilicon area, a contact, or a diffusion area.

In one embodiment, the image comprises an electron microscopy image.

In one embodiment, the image is representative of a respective region of a substrate and the machine-executable instructions further comprise instructions for repeating the machine-executable instructions for each of a plurality of images representative of respective regions of the substrate.

In one embodiment, the machine-executable instructions further comprise instructions to combine the first and second object datasets into a combined dataset representative of the image.

In one embodiment, the machine-executable instructions further comprise instructions to digitally renderer an object-identifying image in accordance with one or more of the first and second object datasets.

In one embodiment, the first and second reusable recognition models are trained with training images augmented with application-specific transformations.

In one embodiment, the application-specific transformations comprise one or more of an image reflection, rotation, shift, skew, pixel intensity adjustment, or noise addition.

In accordance with another aspect, there is provided an image analysis system for recognising each of a plurality of object types of interest in an image, the system comprising: a digital data processor operable to execute object recognition instructions; at least one digital image database comprising the image to be analysed for the plurality of object types, the at least one digital image database being accessible to the digital data processor; a digital storage medium having stored thereon, for each of the plurality of object types, a distinct corresponding reusable recognition model deployable by the digital data processor and associated with a corresponding distinct machine learning architecture; and a non-transitory computer-readable medium comprising the object recognition instructions which, when executed by the digital data processor, are operable to, for each designated type of the plurality of object types of interest, access a digital representation of at least a portion of the image from the at least one digital image database; recognise at least one object of the designated type in the digital representation by deploying the distinct corresponding reusable recognition model; and output a respective object dataset representative of objects of the designated type in the digital representation of the image.

In one embodiment, the system comprises a digital output storage medium accessible to the digital data processor for storing each the respective object dataset corresponding to each the designated type of the plurality of object types of interest.

In one embodiment, the digital data processor is operable to repeatably execute the object recognition instructions for a plurality of images.

In one embodiment, each distinct corresponding reusable recognition model is configured to be repeatably applied to the plurality of images.

In accordance with another aspect, there is provided an image analysis system for digitally refining a digital representation of a segmented image defined by a plurality of pixels each having corresponding pixel value, the system comprising: at least one digital data processor in communication with a digital data storage medium having the digital representation stored thereon, the at least one digital data processor further in communication with a non-transitory computer-readable storage medium having digital instructions stored thereon which, upon execution, cause the at least one digital data processor to, for each refinement pixel to be refined, calculate a characteristic pixel value corresponding to the pixel values of a designated number of neighbouring pixels, digitally compare the characteristic pixel value with a designated threshold value, and upon the characteristic pixel value satisfying a comparison condition with respect to the designated threshold value, assign a refined pixel value to the refinement pixel.

In one embodiment, the characteristic pixel value is calculated in accordance with a digital convolution process.

In one embodiment, the segmented image is representative of an integrated circuit.

In one embodiment, the digital representation corresponds to output of a machine learning-based image segmentation process.

In accordance with another aspect, there is provided an image analysis system for recognising each of a plurality of circuit feature types in an image of an integrated circuit (IC), the system comprising: at least one digital data processor in communication with a digital data storage medium having the image stored thereon, the at least one digital data processor further in communication with a non-transitory computer-readable storage medium having digital instructions stored thereon which, upon execution, cause the at least one digital data processor to, for each designated feature type of the plurality of circuit feature types, digitally define a feature type-specific digital representation of the image; by a reusable feature type-specific object recognition model associated with a corresponding machine learning architecture, recognise objects of the designated feature type in the type-specific digital representation; and digitally refine in accordance with a feature type-specific refinement process output from the feature type-specific object recognition process.

In one embodiment, the non-transitory computer-readable storage medium has stored thereon each of the reusable feature-type specific object recognition models.

In accordance with another aspect, there is provided a non-transitory computer-readable storage medium having stored thereon digital instructions which upon execution by at least digital data processor cause the at least one digital data processor to, for each of a plurality of circuit feature types: digitally define a feature type-specific digital representation of the image; by a reusable feature type-specific object recognition model associated with a corresponding machine learning architecture, recognise objects of the designated feature type in the type-specific digital representation; and digitally refine output from the feature type-specific object recognition process in accordance with a feature type-specific refinement process.

In one embodiment, the non-transitory computer-readable storage medium has further stored thereon each of the reusable feature-type specific object recognition models.

In accordance with another aspect, there is provided a non-transitory computer-readable storage medium having stored thereon digital instructions which upon execution by at least digital data processor cause the at least one digital data processor to: access a digital representation of at least a portion of the image; by a first reusable recognition model associated with a first machine learning architecture, recognise objects of a first object type of the plurality of object types in the digital representation; by a second reusable recognition model associated with a second machine learning architecture, recognise objects of a second object type of the plurality of object types in the digital representation; and output respective first and second object datasets representative of objects of the first and second object types in the digital representation of the image.

In one embodiment, the non-transitory computer-readable storage medium has further stored thereon each of the reusable feature-type specific object recognition models.

In accordance with another aspect, there is provided a non-transitory computer-readable storage medium having stored thereon digital instructions for digitally refining a digital representation of a segmented image defined by a plurality of pixels each having corresponding pixel value, the digital instructions which upon execution by at least digital data processor cause the at least one digital data processor to: for each refinement pixel to be refined, calculate a characteristic pixel value corresponding to the pixel values of a designated number of neighbouring pixels; digitally compare the characteristic pixel value with a designated threshold value; and upon the characteristic pixel value satisfying a comparison condition with respect to the designated threshold value, assign a refined pixel value to the refinement pixel.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIGS. 1A to 1F are SEM images of exemplary integrated circuits highlighting some of the challenges associated with automatic image recognition processes, in accordance with various embodiments;

FIGS. 2A and 2B are schematics of exemplary machine learning-based image recognition processes employing respective machine learning architectures to recognise respective object types in images, in accordance with various embodiments;

FIG. 3 is a schematic of two exemplary image pre-processing steps, in accordance with various embodiment;

FIGS. 4A and 4B are images of exemplary segmentation outputs from a machine learning recognition process, in accordance with various embodiments;

FIGS. 5A and 5B are images of exemplary image inputs and corresponding machine learning-based segmentation outputs, in accordance with various embodiments;

FIGS. 6A and 6B are plots showing exemplary spectral bias in, respectively, wire segmentation and via detection, in accordance with various embodiments; and

FIGS. 7A and 7B are images of exemplary image inputs and corresponding machine learning-based detection outputs, and FIG. 7C is a set of input images and corresponding machine learning based detection outputs overlaid thereon, in accordance with various embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

Reverse engineering (RE) is now a common practice in the electronics industry with wide ranging applications, including quality control, the dissemination of concepts and techniques used in semiconductor chip manufacture, and intellectual property considerations with respect to assessing infringement and supporting patent licensing activities.

However, with ever-increasing integration levels of semiconductor circuits, RE has become increasingly specialised. For instance, many RE applications often require advanced microscopy systems operable to acquire thousands of images of integrated circuits (ICs) with sufficient resolution to visualise billions of micron and sub-micron features. The sheer number of elements that must be processed demands a level of automation that is challenging, particularly in view of the oft-required need of determining connectivity between circuit elements that are not necessarily logically placed within a circuit layer, but rather disposed to optimise use of space.

Various approaches for automatically analysing ICs have been proposed. One method is described in U.S. Pat. No. 5,694,481 entitled “Automated Design Analysis System for Generating Circuit Schematics from High Magnification Images of an Integrated Circuit” and issued to Lam, et al. on Dec. 2, 1997. This example, which illustrates an overview of the IC RE process in general, discloses a method for generating schematic diagrams of an IC using electron microscopy images. Due to the high resolution required to image circuit features, each layer of an IC layer is imaged by scanning many (tens to millions of) subregions independently, wherein such ‘tile’ images are then mosaicked to generate a more complete 2D representation of the IC. These 2D mosaics are then aligned in a third dimension to establish a database from which schematics of the IC layout are generated.

With respect to the actual extraction of circuit features, however, such automatic processes may be challenged by many factors, not the least of which relate to the nature of the imaging techniques required to visualise such small components. For instance, the relatively widely used processes of scanning electron microscopy (SEM), transmission electron microscopy (TEM), scanning capacitance microscopy (SCM), scanning transmission electron microscopy (STEM), or the like, may produce images with an undesirable amount of noise and/or distortion. While these challenges are manageable for some applications when a circuit layout is already known (e.g. IC layout assessment for compliance with design rules), it is much more challenging to extract circuit features from imperfect data in an automated fashion when there is no available information about the intended circuit design.

Various extraction approaches have been proposed. For instance, the automated extraction of IC information has been explored in U.S. Pat. No. 5,086,477 entitled “Automated System for Extracting Design and Layout Information from an Integrated Circuit”, issued Feb. 4, 1994 to Yu and Berglund, which discloses the identification of circuit components based on a comparison of circuit features with feature templates, or feature template libraries. However, such libraries of reference structures are incrementally built for each unique component and/or configuration. In view of how the components of even a single transistor (i.e. a source, gate, and drain), or a logic gate (e.g. OR, NAND, XNOR, or the like) may have a wide range of configurations and/or shapes for performing the same function, this approach is practically very challenging, often resulting in template matching systems requiring a significant amount of operator intervention, and which are computationally very expensive, and limited to specific component configurations (i.e. lack robustness).

For instance, a NAND gate may comprise a designated number and connectivity transistors in series and in parallel. However, the specific configuration and placement of transistor features (e.g. the size, shape, and/or relative orientation of a source, gate, and drain for a transistor), and the configuration of the different transistors of the NAND gate, may vary even between even adjacent gates in an IC layer. An operator would therefore need to identify each transistor geometry present in each gate for inclusion into a template library, wherein automatic extraction of subsequent transistor components may only be successful only if a previously noted geometry is repeated.

Despite these deficiencies, this approach remains common in IC RE practice. For example, U.S. Pat. No. 10,386,409 entitled ‘Non-Destructive Determination of Components of Integrated Circuits’ and issued Aug. 20, 2019 to Gignac, et al., and U.S. Pat. No. 10,515,183 entitled ‘Integrated Circuit Identification’ and issued Dec. 24, 2019 to Shehata, et al., both disclose the identification of circuit elements based on pattern matching processes.

More generally, it may be important for various applications to extract specific types of features from images of ICs. For instance, many RE or development applications may rely on the identification of wires, vias, diffusion areas, polysilicon features, or the like, from SEM images. While a common approach to this end is image segmentation, automatic extraction of features is challenged by, among other aspects, low segmentation accuracy arising from noisy images, contamination, and intensity variation between circuit images. Resultant errors may be very time consuming to correct by an operator.

Existing circuit segmentation processes are also highly dependent on user-tuned parameters to achieve reasonable results. For example, Wilson, et al. (Ronald Wilson, Navid Asadizanjani, Domenic Forte, and Damon L. Woodard, ‘Histogram-based Auto Segmentation: A Novel Approach to Segmenting Integrated Circuit Structures from SEM Images’, arXiv: 2004.13874, 2020) discloses an intensity histogram-based method to automatically segment integrated circuits. However, there is no quantitative analysis of performance in this report with respect to different integrated circuit images having significant intensity variation. Moreover, while focus is placed on wire segmentation, there is lacking adequate extraction of information with respect to vias, such as accurate via location data, which is an important aspect of many semiconductor analysis applications. Similarly, Trindade, et al. (Bruno Machado Trindade, Eranga Ukwatta, Mike Spence, and Chris Pawlowicz, ‘Segmentation of Integrated Circuit Layouts from Scanning Electron Microscopy Images’, 2018 IEEE Canadian Conference on Electrical Computer Engineering (CCECE), 1-4, DOI: 10.1109/CCECE.2018.8447878, 2018) explores the impacts of different pre-processing filters on scanning electron microscopy (SEM) images, and proposes a learning-free process for integrated circuit segmentation. However, again, the effectiveness of the proposed approach relies on a separation threshold, which may be challenging if not impossible to generically establish across images with a large variation in intensity or in circuit configurations. Moreover, depending on various aspects of an image (e.g. quality, noise, contrast, or the like), such a threshold may not even exist.

A possible approach to automating the identification of IC features is through the employ of a machine learning (ML) architecture for recognising specific features or feature types. However, such platforms remain challenged by issues relating to, for instance, image noise, intensity variations between images, or contamination. Moreover, unlike with image recognition processes applied to conventional photographs, IC images may often be discontinuous, histograms may often be multi-modal, and the relative location of modes within histograms may change between image captures. Mode distributions for components (e.g. wires, vias, diffusion areas, or the like) may overlap. For some applications, the size and distribution of features may present a further challenge to analysis. For example, vias tend to be numerous, small, and sparsely distributed, similar to contamination-based noise. Further, image edges may be problematic, wherein, for example, some wires may be difficult to distinguish from vias when they are ‘cut’ between adjacent images (i.e. edge cutting). As described further below, this problem may be exacerbated by the fact that, due to memory and/or processing constraints, machine learning processes may require cutting images into smaller sub-images.

Generally, ML processes known in the art still require user tuning of user-tuned parameters or hyperparameters. With respect to IC component recognition, this may relate to a user being required to hand-tune parameters for, for instance, every grid or image set, and/or those having differing intensities and/or component distributions. Such platforms or models are thus not generic, requiring user intervention to achieve acceptable results across diverse images or image sets. Moreover, ML systems are not one-size-fits-all, wherein, for instance, different outputs may be preferred for different object types. For example, many applications may require accurate information with respect to via location(s) within an IC, while for wires, continuity and/or connectivity may be a primary focus. This may be different from conventional machine learning approaches, which may often have a particular output goal (e.g. pixel-by-pixel segmentation), and/or may be evaluated using a consistent metric (e.g. recall, precision, or confidence score). For example, Lin et al. (Lin, et al., ‘Deep Learning-Based Image Analysis Framework for Hardware Assurance of Digital Integrated Circuits’, 2020 IEEE International Symposium on the Physical and Failure Analysis of Integrated Circuits (IPFA), pp. 1-6, DOI: 10.1109/IPFA49335.2020.9261081, 2020) proposes a deep learning-based approach to recognising electrical components images. However, the proposed process relates to a fully convolutional network that is used to perform segmentation of target features within SEM images of ICs. That is, both vias and metal wire features are recognised using the same segmentation process executed using the same machine learning architecture. However, and in accordance with various embodiments herein described, different image features may be more suitably recognised using different processes and/or architectures. Moreover, the machine learning models of Lin et al., despite being applied to images with less than noise than is characteristic of those acquired in industrial applications, are not reusable between images of different ICs, or even different IC layers. That is, the systems and processes of Lin et al. require retraining for each new image to be processed, which is not practical for industrial applications.

In, for instance, IC reverse engineering applications, it may be desirable for an output (e.g. a segmentation output for wires) to have both correct electrical connectivity between wires, but also maintain a desired level of aesthetic quality. That is, it may be preferred to output a segmentation result that has correct electrical connectivity, while approximating how a human would segment an image. However, some aspects of conventional segmentation may be less critical. For example, a small hole in a wire, or a rough edge thereof, may be less critical for an application than continuity (i.e. electrical conductivity). On the other hand, via placement within an IC with respect to wires and the like may be more important than a via shape. Accordingly, evaluation of the quality of ML outputs with respect to these different objects may rely on different aspects. Further, it may be preferred to recognise different objects or types in accordance with fundamentally different recognition processes. For example, with respect to circuit feature recognition from SEM images, segmentation may provide an effective means of recognising wires and/or diffusion areas. However, segmentation may be less effective for via recognition than a detection process, depending on the application at hand. Accordingly, and in accordance with various embodiments, different processes may be preferably applied for different image recognition aspects or object types.

At least in part to this end, the systems and methods described herein provide, in accordance with different embodiments, different examples of image analysis methods and systems for recognising each of a plurality of object types in an image. While various exemplary embodiments described relate to the recognition of circuit features (e.g. wires, vias, diffusion areas, and the like) from integrated circuit images, it will be appreciated that such embodiments may additionally or alternatively be deployed to recognise objects from images or digital representations thereof in the context of different applications. For example, while some embodiments relate to the recognition of wires and vias from digital representations (e.g. digital SEM images or portions thereof) of ICs, other embodiments relate to the recognition of different object types (people, structures, vehicles, or the like) from other forms of media (e.g. photographs, videos, topographical maps, radar images, or the like).

Generally, embodiments herein described relate to the recognition of respective object types from images using respective machine learning recognition models, architectures, systems, or processes. It will be appreciated that respective machine learning processes or models may be employed from a common computing architecture (either sequentially or in parallel), or from a plurality of distinct architectures or networks. For example, a networked computational system may access different remote ML architectures via a network to perform respective ML recognition processes in accordance with various ML frameworks, or combinations thereof, in accordance with some embodiments. Moreover, it will be appreciated that the systems and methods herein described may be extended to any number of object types. For instance, a plurality of object types (e.g. 2, 3, 5, 10, or N object types) may be recognised using any suitable combination of ML architectures. For instance, one embodiment relates to the recognition of five object types from images using three different machine learning architectures. One or more of these machine learning architectures may be employed in parallel for independent and simultaneous processing, although other embodiments relate to the independent sequential processing of images or digital representation thereof.

It will therefore be appreciated that various aspects of machine learning architectures may be employed within the context of various embodiments. For example, the systems and methods herein described may comprise and/or have access to various digital data processors, digital storage media, interfaces (e.g. programming interfaces, network interfaces, or the like), computational resources, servers, networks, machine-executable code, or the like, to access and/or communicate with one or more machine learning networks, and/or models or digital code/instructions thereof. In accordance with some aspects, embodiments of the systems or methods may themselves comprise the machine learning architecture(s), or portions thereof.

Moreover, it will be appreciated that machine learning architectures or networks, as described herein, may relate to architectures or networks known in the art, or portions thereof, non-limiting examples of which may include ResNet, HRNet (e.g. HRNet-3, HRNet-4, HRnet-5, or the like), pix2pix, or YOLO, although various other networks (e.g. neural networks, convolutional neural networks, or the like) known or yet to be known in the art may be employed and/or accessed. Further, various embodiments relate to the combination of various partial or complete ML networks. For example, one embodiment relates to the combination of aspects of ResNet, Faster R CNN, and/or HRNet to recognise an object type from images. In accordance with yet other embodiments, and depending on, for instance, the object type to be recognised and/or the needs of a particular application, various layers and/or depths of ML networks may be employed to process images for recognising objects therein. It will further be appreciated that, as referred to herein, a machine learning architecture may relate to any one or more ML models, processes, code, hardware, firmware, or the like, as required by the particular embodiment or application at hand (e.g. object detection, segmentation, or the like).

For instance, a non-limiting example of a machine learning architecture may comprise an HRNet-based machine learning framework (e.g. HRNet-3, HRNet-4, or the like). An HRNet-based framework and/or architecture may be used to train and/or develop a first machine learning model for a particular application (e.g. wire segmentation), wherein the model is reusable on a plurality of images (i.e. is sufficiently robust to segment wires from a plurality of images, IC layers, images representative of different ICs, or the like). In accordance with some embodiments, a machine learning architecture may, depending on the context, and as described herein, comprise a first machine learning model (or a combination of models) that may be employed in accordance with the corresponding machine learning framework (e.g. HRNet) to recognise instances of an object type in a plurality of images.

In accordance with some embodiments, a machine learning architecture may, additionally or alternatively, comprise a combination of machine learning frameworks (e.g. HRNet and ResNet). That is, the term ‘machine learning architecture’, as referred to herein, may relate not only to a single machine learning framework dedicated to a designated task, but may additionally or alternatively relate to a plurality of frameworks employed in combination to recognise instances of a designated object type. Moreover, a machine learning architecture, or the combination of machine learning frameworks thereof, may produce different forms of output (e.g. datasets related to object detection versus datasets related to object segmentation) depending on the application at hand.

Various embodiments relate to the selection of designated machine learning architectures and/or associated models that are well suited to particular tasks (e.g. analysing images to recognise each of designated object types), wherein an appropriate machine learning architecture and/or associated model is designated for recognising objects of interest of each object type of interest to be recognised. Moreover, and in accordance with some embodiments, selection of an appropriate machine learning architecture (e.g. one of a designated and/or appropriate sophistication), and appropriate training of a designated associated model (e.g. training in accordance with a designated breadth of training images, including, for instance, selected image transformations, the number of training images, or the like) for each object type to be recognised enables the generation of generic models that may be reused across multiple images (i.e. do not need to be retrained across image sets), and are robust to perform accurately even in the presence of noisy or otherwise challenging image sets (e.g. electron microscopy images of integrated circuits acquired for industrial and/or reverse engineering applications). For example, various embodiments improve computational systems and methods through the provision of machine learning frameworks that do not require user intervention, model retraining, and/or parameter tuning between image analyses through, among other aspects, the selection of appropriate machine learning architectures for object-specific detection using models appropriately trained for use therewith. Models trained and exercised in accordance with embodiments hereof are less sensitive to noise in comparison with existing frameworks, and provide improved generality.

For example, and without limitation, while a first machine learning architecture comprising a first machine learning framework (e.g. HRNet) may employ a first machine learning model to output a segmentation result for recognising wires in an IC image, a second machine learning architecture may comprise a combination of machine learning frameworks (e.g. HRNet and ResNet, or another combination or two, three, or more frameworks) to execute a second machine learning model (or combination of models) to output a detection result corresponding to vias detected (i.e. not segmented) from the same IC image that served as input for the first machine learning architecture. In accordance with some embodiments, the use of such respective machine learning architectures for performing respective image recognition tasks for respective objects types may improve robustness of machine learning models and/or tasks for use with a plurality of (or indeed many, or all) images to be processed for a particular application. Such embodiments may thus relate to an improvement over conventional approaches which may employ the same machine learning architecture, framework, process, or model, to recognise each of a plurality of object types which, among other deficiencies, results in poor model robustness (i.e. a lack or reusability across images).

In accordance with various embodiments, the systems and methods herein described relate to a pipeline for the recognition of various objects from images or digital representations thereof through the employ of object-specific machine learning architectures, frameworks, or models that may be both free of user-tuned parameter (i.e. are generic) and automatic (i.e. do not require human intervention), and are robust to be reapplied to a plurality of images (e.g. are reusable across a plurality of images). Moreover, various embodiments relate to ML models and/or architectures that may generate results for different images without the need for image-or image type-specific retraining. Some embodiments employ image pre-processing to prepare or define digital representations of images (e.g. binary representations of surface, such as an IC layer, tiles or patches thereof, or the like), and/or refinement steps to post-process output from a machine learning architecture. For exemplary purposes, various of the embodiments herein described comprise such pre-processing and/or refinement steps. However, it will be appreciated that other embodiments herein contemplated may omit such processes, or have variants exchanged therewith, and that objects may be recognised from images in accordance with the object-specific machine learning processes, models, and/or systems described herein, in accordance with different embodiments.

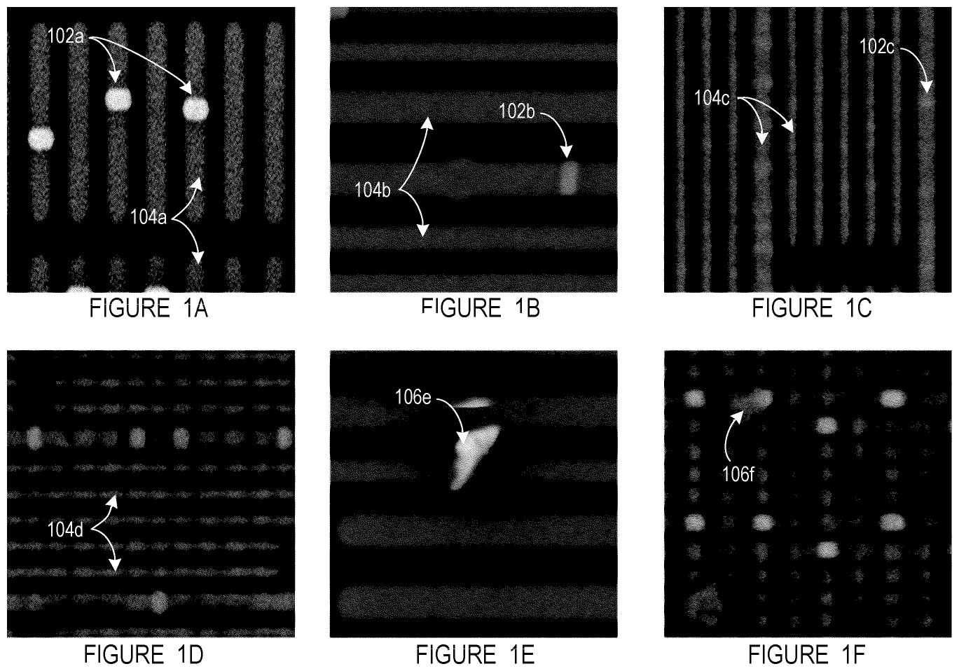

With reference to the exemplary application of IC feature identification, various challenges exist with respect to machine learning recognition processes. FIGS. 1A to 1F highlight some of these challenges, wherein exemplary SEM image patches (i.e. defined portions) of IC images are shown. In this example, FIGS. 1A to 1C comprise image patches showing a variation of feature intensity across different ICs. For instance, vias 102a in FIG. 1A are noticeably brighter than vias 102b in FIG. 1B or vias 102c in FIG. 1C, the latter of which are barely visible. Accordingly, conventional intensity-based thresholding techniques for segmentation-based via identification would be very challenging in view of the low contrast between wires and vias in, for instance, FIG. 1C. FIG. 1D, on the other hand, shows an exemplary IC image patch characterised by a high degree of noise. In this case, wires 104d are aligned horizontally, but vertical line noise results in areas between wires having a high intensity, and may complicate feature extraction processes. FIGS. 1E and 1F show exemplary images having contamination 106e and 106f on the surface of the IC layer that may further challenge feature identification. For example, contamination 106e, having relatively high intensity, may be susceptible to mischaracterisation as a via using conventional recognition processes. Contamination 106f, on the other hand, partially blocks a via, which may lead to the via being missed during a detection process.

Moreover, compared to natural image perception tasks, IC SEM image segmentation requires less emphasis on high-level semantic information, as vias and wires in SEM images tend to have relatively regular shape and size. For some applications, a pipeline may comprise binary segmentation tasks, and/or single class object detection tasks. Accordingly, texture information in high-resolution feature maps may be relatively more important for IC segmentation than for natural image processing. Accordingly, for such applications, and in accordance with some embodiments, an ML architecture may comprise a convolutional neural network (CNN) configured to maintain high-resolution feature maps. For example, a low-resolution path network (e.g. ResNet) that extracts visual features form images by downsampling feature maps from high to low resolution may not be preferred for various segmentation tasks. Rather, and in accordance with some embodiments, a segmentation task (e.g. wire segmentation from IC SEM images) may employ a CNN framework or process, such as HRNet, which may parallelly extract features from multi-resolution feature maps. Accordingly, such a process may maintain high-resolution feature maps during the majority or entirety of a feature extraction process. Output therefrom, however, may then serve as input for various other ML processes, such as those employed by ResNet, to perform various other tasks, such as via detection, in accordance with some embodiments.

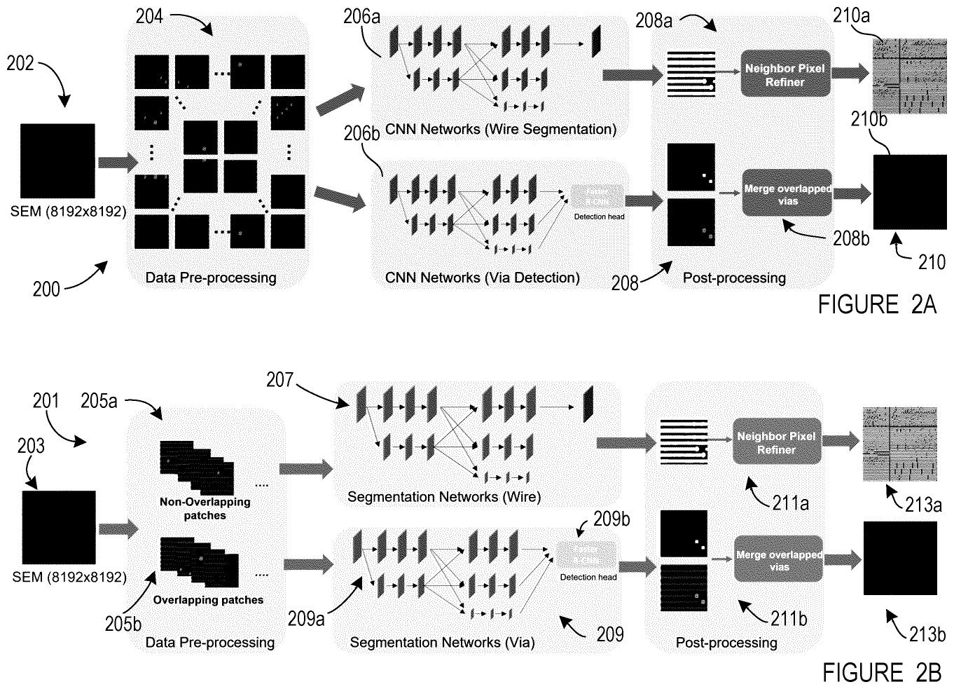

For example, FIG. 2A shows, in accordance with some embodiments, an exemplary process 200 for the recognition of different object types using respective machine learning architectures and/or models. In this example, the image to be processed comprises an 8192×8192-pixel SEM image 202 of an IC layer comprising a number of wires and vias to be recognised, although it will be appreciated that different image types and/or resolutions may be processed to extract any number of objects and/or object types, in accordance with different embodiments. The image 202 is pre-processed 204 to define image patches (e.g. respective image portions corresponding to different spatial regions of the image 202), whereby respective first and second machine learning architectures 206a and 206b (or machine learning processes or trained models 206a and 206b) process image patches independently based at least in part on the respective object types to be recognised (e.g. wires and vias). Respective processes 208a and 208b of a refinement step 208 act on output from the machine learning architectures 206a and 206b, whereupon respective outputs 210a and 210b are produced 210. In one embodiment, image patches are recombined and/or merged to produce respective output images 210a and 210b having a resolution comparable to the input image 202. These exemplary process steps will be further described below with respect to various embodiments.

In accordance with another embodiment, FIG. 2B schematically illustrates another image recognition process 201. In this example, a digital representation 203 of an SEM image of an IC serves as input to the recognition process 201 for recognising respective objects types, which in this case corresponds to the segmentation of wires and the detection of vias from the input image 203. The process 201 comprises pre-processing the image to define image patches (e.g. sub-images of smaller size than the input image 203) in accordance with respective pre-processing steps for each object type (e.g. different pre-processing processes for wires and vias). For example, FIG. 2B schematically illustrates a first pre-processing step 205a corresponding to defining non-overlapping image patches for eventual segmentation of wires from image patches. However, pre-processing step 205b corresponds to defining from the same input image 203 overlapping image patches based on, for instance, downstream via detection processing steps. In accordance with another embodiment, respective pre-processing steps 205a and 205b may both comprise the definition of overlapping patches, but with different amounts of overlap. For example, the pre-processing step 205a may comprise defining patches in accordance with an overlap that is 10%, 50%, 80%, or the like, of an overlap of the pre-processing step 205b.

In the exemplary embodiment of FIG. 2B, respective pre-processed image patches 205a and 205b may serve as input for further processing using respective machine learning architectures 207 and 209. For example, images patches for wire recognition may be processed by a machine learning architecture 207 comprising a segmentation network. It will be appreciated that, in accordance with some embodiments, the first machine learning architecture 207 may comprise a trained machine learning model 207. However, in accordance with another embodiment, the first machine learning architecture may comprise an untrained network, wherein image patches 205a may serve as, for instance, training images. Either concurrently, prior to, or after execution of the first machine learning process 207, images patches 205b for via recognition may serve as input for a second machine learning architecture 209. In this example, the second machine learning architecture 209 serves as framework for detecting vias in image patches 205b, which does not necessarily comprise a segmentation process, although it may, in some embodiments. In this example, the second machine learning architecture 209 comprises a combination of machine learning networks or frameworks 209a and 209b. That is, and in accordance with some embodiments, object recognition (e.g. via detection) may comprise the combined use of machine learning frameworks, wherein a first machine learning framework 209a provides as output input to be processed by a second machine learning framework 209b. As described above, it will be appreciated that one or more machine learning frameworks 209a or 209b, or the entire second machine learning architecture 209, may comprise, for instance, trained machine learning models, in accordance with some embodiments.

Process 201 may then comprise post-processing of respective outputs from respective machine learning architectures 207 and 209. For example, wire segmentation output from the first ML architecture 207 may be subjected to a refinement process 211a in which segmentation pixels are refined in accordance with a convolutional refinement process. A different refinement process 211b may operate on via detection output from the second ML architecture 209 to, for instance, merge outputs corresponding to different image patches to remove duplicated and/or incomplete vias in overlapping regions defined during pre-processing 205b. Respective outputs 213a and 213b may thus be produced for user consumption and/or further processing, in accordance with various embodiments.

It will be appreciated that processes such as those presented in FIGS. 2A and 2B may provide several advantages over conventional machine learning-based recognition processes. For example, Lin et al. discloses the use of a same ML-based segmentation architecture for recognising both metal wires and vias from an image set. However, such systems or processes, among other disadvantages, lack robustness, wherein new ML models must be trained for each image set representing a layer of an IC (i.e. models are not reusable). This is impractical for industrial applications, wherein tens of thousands of images or image sets corresponding to different IC layer regions, different IC layers, and different ICs may require rapid processing. Various embodiments as herein described, however, provide for robust machine learning models that may be applied to different image sets (e.g. are reusable), at least in part through the use of respective machine learning architectures for different object types (e.g. wires, vias, contact, diffusion areas, or the like). At least in part to this end, the following description is provided to further describe, among other aspects, various elements of systems and processes for recognising a plurality of objects of interest from images in a robust manner, non-limiting examples of which may relate to those of FIGS. 2A and 2B.

In accordance with various embodiments, image recognition processes, systems, architectures, and/or models may benefit from pre-processing prior to machine learning processing. For example, various machine learning architectures (e.g. CNN networks) may best perform when processing images of a designated size and/or resolution, and/or images below a threshold size and/or resolution. Accordingly, and in accordance with some embodiments, a pre-processing step (e.g. pre-processing 204) may comprise defining images of a designated size and/or resolution from (i.e. at least a portion of) a larger image. It will be appreciated that such images and/or image patches may be accessed from a local machine, or may be accessed from a remote storage medium (e.g. over the internet), in accordance with different embodiments.

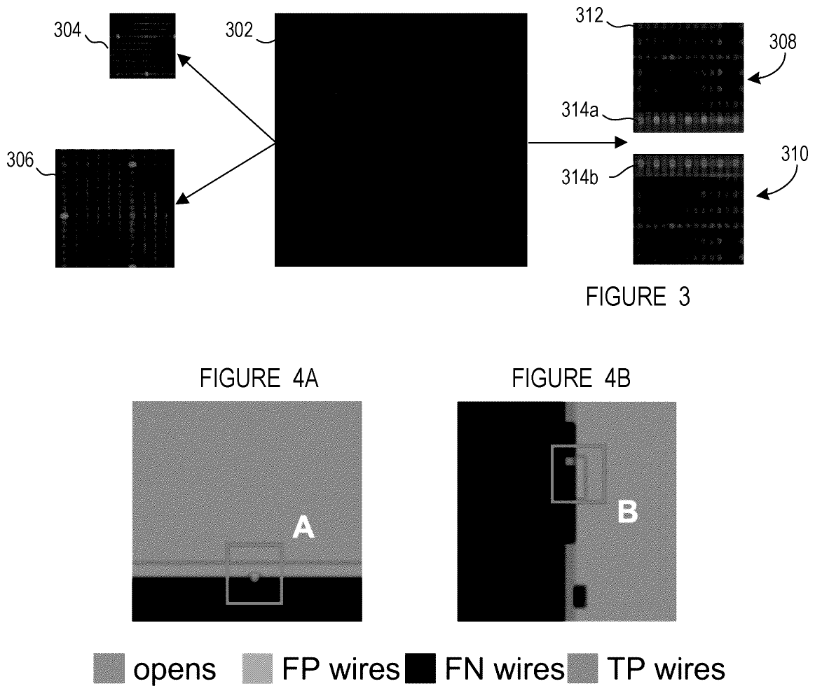

Various pre-processing methods are herein contemplated depending on, for instance, the type of image(s) to be processed, the type of objects to be recognised, the size and/or resolution of an initial image, the type of machine learning process(es) employed, or the like. FIG. 3 schematically illustrates two proposed image pre-processing routines that may be employed for IC feature recognition. In this example, the image 302 to be processed comprises a large, high-resolution SEM image of a relatively large region of an IC comprising many wires and vias. Such an image may be too large for, for instance, the processing resources or use time of a machine learning architecture allotted to a user to adequately process features or train a model with sufficient quality or accuracy for a particular application (e.g. wire and via recognition). Further, such an image may simply comprise too many features to adequately train a recognition process in a reasonable time.

Accordingly, an image pre-processing step may be employed to define sub-images 304 and 306 (also herein referred to as image patches) of a designated resolution and/or size that are more readily and/or accurately processed by subsequent machine learning or machine recognition processes. In this example, two different image sizes corresponding to patches 304 and 306 are schematically shown. It will be appreciated that, depending on the application at hand, such differing image sizes may be defined from an input image 302. However, various embodiments relate to defining consistently sized image patches, wherein the majority or entirety of the input image 302 is represented by corresponding image patches corresponding to respective areas of the input image 302. For example, an input image 302 may have defined therefrom an array of image patches of consistent size/resolution such that, when mosaicked or assembled, reproduce the input image 302. It will be appreciated that such a consistent size may be designated based on, for instance, the particular machine learning process to be employed, the number or amount of dedicated resources and/or time allotted for various machine learning processes, a density of features in the image 302 and/or images patches 302 or 304, the type of object to be recognised, or the like.

For example, and in accordance with some embodiments, a high-resolution SEM image 302 may be digitally ‘cut’ into SEM image patches sized based at least in part on an intensity difference between background and a particular feature type that is known or automatically digitally inferred. In one embodiment, such image patches may be defined for eventual segmentation of wires in an IC SEM image, wherein the intensity difference between background and wires may be relatively stark, and wherein the shape of wires may not vary tremendously between image patches. Accordingly, images may be defined to provide a desirable balance of ‘local’ features and texture to classify images for wire segmentation in view of computation resources required to do so, in accordance with some embodiments. In accordance with other embodiments, a patch size may be defined based on limitations present in memory and processing speeds of a computational resource (e.g. GPU). However, it will be appreciated that various embodiments relate to the selection of patch sizes based on the particular application at hand.

As described above, the edges of images may provide challenges for image recognition processes. For example, a via located on the edge of an image may be ‘cut’ and thus appear as incomplete in an image, or a wire end that is cut between images may appear in one or more images to be a via, and be improperly recognised. Such ‘edge cutting’ may be exacerbated by the definition of image patches, wherein a greater proportion of image area has associated therewith an edge that may lead to such challenging recognition scenarios. Accordingly, FIG. 3 also schematically illustrates one approach to dealing with such edge effects, in accordance with various embodiments. In this example, adjacent image patches 308 and 310 are defined from the input image 302. However, in this case, the image patches have defined a designated border region 312 associated therewith, from which subsequent recognition processes may effective discard features recognised therein. For example, and in accordance with one embodiment, a 50-pixel border 312 may be defined such that any incomplete edge vias or detected via-like objects may be dropped from further consideration. However, it will be appreciated that any appropriate border 312 may be designated depending on, for instance, an expected feature size (e.g. previously automatically determined or estimated from an average feature size, median size, or the like) and/or density. In accordance with yet another embodiment, borders or overlaps may further relate to specific object types. For example, and without limitation, wire segmentation applications may not employ overlapping image patches (although other embodiments may do so), while overlapping patches may be employed for via detection applications to, for instance, mitigate edge cutting effects.

Furthermore, and in accordance with some embodiments, image patches 308 and 310 may be defined in accordance with a designated overlap region 314a and 314b between neighbouring patches. That is, a pre-processing step may define image patches 308 and 310 in accordance with a consistent size, but with a designated overlap region corresponding to a common region of the input image 302 that is present in each of at least two neighbouring patches 308 and 310. In accordance with some embodiments, such an overlap region 314a and 314b may be designated based on an expected feature size, or another appropriate metric(s), or as a function thereof. For example, in embodiments associated with a discard border region 312, an overlap region may be defined based on one or more of the border region 312 size and an expected via size. Such definition may aid subsequent processing with respect to, for instance, via recognition, and thus for the accurate distinction of vias from wire ends clipped across neighbouring image patches. In accordance with one exemplary embodiment, an overlap region 314a and 314b may be defined to be twice that of a border region 312. In some embodiments, the overlap region 314a and 314b may be defined as 100 pixels along each edge of an image and/or image patch. In accordance with some embodiments, an overlap region 314a and 314b, as well as the border region 312 employed for, for instance, discarding features recognised as being solely therein, may be defined such that features (e.g. vias, clipped wires, etc.) discarded from the border region 312 may still be detected in the overlap region 314a and 314b, thereby reducing the number of false positives while not neglecting features disposed near edges of images or image patches. In accordance with yet other embodiments, an overlap region size may be a function of or related to a downstream process. For example, various refinement processes applied to machine learning process outputs may rely on various convolutional and/or threshold comparison processes, as will be further described below. For such embodiments, it may be desirable to define an overlap and border region such that the overlap between images is big enough to present edge vias on each of neighbouring patches.

In accordance with different embodiments, overlapping regions 314a and 314b or border regions 312 defined for image patches may be sized based on a downstream process, and the nature of the images being processed. For example, various embodiments relate to the processing of image patches using machine learning models, such as a CNN. As comprising convolutional filters, the response from CNN processes may generally be less accurate around edges of an image. Accordingly, if a network comprised, for instance, 4 layers of 2'3 convolutional downsampling, then, in accordance with one embodiment, one may trim 16 (i.e. 24) pixels from the border of any CNN result, retaining only the middle portion of images. However, such border or overlap regions may be differently defined depending on, for instance, the nature of the objects being recognised, the ability of a process to recognise object types near edges of images, how much information may be discarded due to downsampling, or how important such data was to begin with (i.e. how much of the missing information could have been inferred from a subset of the remaining information based on, for instance, the strength of correlations within the image).

In accordance with some embodiments, image patches may be defined differently depending on, for instance, the type of object to be recognised therein, and the particular process employed to recognise the designated object. For example, to recognise (e.g. segment) wires from an SEM image 302, the input image 302 may have defined therefrom a mosaic of image patches 304 of consistent size that do not overlap, thereby minimising the amount of image patches for processing. A via recognition process (e.g. via detection), on the other hand, may relate to the definition of image patches comprising an overlap region 314a and 314b, thereby taking advantage of various aspects thereof (e.g. reduced false positives, improved detection, merging processes described below, or the like) based on the nature and/or size of vias in images. Moreover, such embodiments may be complementary for the accurate recognition of different object types. For example, while clipped wires may prove troublesome for a conventional recognition system or process related to non-overlapping images when taken individually, when performed in combination with a via recognition process employing an overlap region, an automatic (e.g.

digitally executed) cross-reference between respective outputs from respective processes may, for instance, reduce or eliminate errors arising from misidentified vias and/or wires, in accordance with various embodiments.

It will be appreciated that, in accordance with various embodiments, the same image (e.g. SEM image 302) may be subject to different pre-processing steps for different object types. For example, and as noted above, distinct wire segmentation and via detection processes may employ different image patches defined from the same input image 302. For instance, an input image may have defined therefrom a 20×20 array of non-overlapping image patches for subsequent independent processing. The same input image 302 may have defined therefrom for via detection a 25×25 array of overlapping image patches corresponding to the same total area defined by the 20×20 array of patches for wire segmentation, wherein each via detection patch is the same size as those in wire segmentation array, but due to the overlap of patches defined for via detection, the array of via detection patches is greater in number. Naturally, this difference in array size may correspond to, for instance, the ratio between each patch dimension and the overlap region defined therefrom, which may be defined automatically and/or based on the application at hand.

Such image patches may serve as input for various machine learning processes, architectures, or models, in accordance with various embodiments. As will be appreciated by the skilled artisan, machine learning models may require training to adequately detect one or more object types. That is, before deployment on an unknown sample to perform a recognition or inference process, a machine learning model may receive as input images on which the process is trained. For example, user-labeled images (e.g. SEM image patches having previously recognised IC features, non-limiting examples of which may include segmented wires or diffusion areas, detected wires or vias, or the like), may serve as a training set on which respective machine learning models are developed. The effectiveness of training is often dependent on the quantity, quality, and general representativeness of images from which a model is trained. However, depending on, for instance, the nature, sensitivity (e.g. privacy-related concerns), and/or abundance of such images, or their ease or cost of procurement, the number of images available for training may be limited.

To this end, various means of generating a plurality of training images from a single input are known. For example, it is not uncommon to generate a plurality of images having different brightness, colour, and orientation adjustments (collectively referred to herein as image transformations) from the same input image, with the aim of increasing a robustness of a machine learning model with limited training data. Such methods may be employed in, for instance, natural image perception applications. However, various embodiments herein described contemplate the selection of designated image transformations that are applied to training images based on the particular application at hand. That is, while some embodiments herein described relate to the selective application of designated machine learning processes, architectures, or models for selected designated object types, some embodiments further relate to the selection of designated image transformations to be applied to training images to effectuate an efficient learning process for a machine learning model. While conventional practices may dictate, for instance, that any and all available transformations be applied to augment an input image to generate a high number of training images, various embodiments herein described relate to performing a subset of available image transformations to an input image to, for instance, save on computational time and cost associated with training a machine learning model, while also improving resultant models through, for instance, reducing unrealistic ‘noise’ on which models are trained. As a non-limiting example, conventional practices may relate to the application of many rotational transformations to an input image (e.g. the same image is duplicated with 1°, 2°, or 5° rotations up to) 360° to generate a high number of variable training images. While this may be beneficial for natural image recognition processes, wherein it is likely for a model to attempt to, for instance, identify faces or other common objects at any number of angles in an image, it is not necessarily beneficial for other applications. For example, with respect to the recognition of IC features, which are typically aligned horizontally and/or vertically, there may be little benefit to training a machine learning model on images with features rotated, for instance, 25° from horizontal. Similarly, there may be little benefit to training a model for use in self-driving cars to recognise pedestrians that are upside down.

Accordingly, and in accordance with various embodiments, training of machine learning processes may be application-dependent. For example, rather than applying any and all transformations to an input image patch for training, a model be trained on a plurality of labeled image patches subjected to rotations in increments of 90°, wherein features remain oriented horizontally or vertically. In accordance with some embodiments, similar selective transformations may be applied to a limited training set of images to efficiently train machine learning models in an application-specific manner. For example, image patches of an IC as described above may be subject to horizontal and vertical reflections to simulate different, but realistic, circuit feature distribution scenarios. For a process related to self-driving cars and pedestrian recognition, training image transformations may therefore selectively neglect vertical reflections or 180° rotations. On the other hand, an SEM image patch may be subjected to various intensity and/or colour distortions or augmentations to simulate realistic SEM imaging results across an IC. In one embodiment, this is achieved through the addition of image noise, wherein pixels (e.g. each pixel) is increased or reduced in brightness in accordance with a designated distribution of noise (e.g. between −5 and +5 of pixel intensities). Thus, in accordance with various embodiments, a limited dataset of training images may be augmented to improve, in an application-specific manner, machine learning training efficiency and/or quality, and ultimate model performance.

For exemplary purposes, the following description relates to the employ of respective machine learning models for the recognition of wires and vias from SEM images. However, it will be appreciated that, in accordance with different embodiments, similar or analogous training methods and/or models may be employed for the recognition of different types of IC features (e.g. diffusion areas, or the like), or indeed general or natural image object types (e.g. vehicles, signs, faces, objects, or the like). While various aspects of the following description relate to the training of a machine learning model or process, which indeed falls within the scope of some of the various embodiments herein contemplated, it will be appreciated that various other embodiments relate the use of respective machine learning models or processes that have already been trained to recognise various objects and/or object types from images. For example, various embodiments relate to the use of a first trained machine learning model to recognise (e.g. segment) wires from SEM images, and the use of a second distinct trained machine learning model to recognise (e.g. detect) vias from the same SEM images, or portions thereof, to output respective datasets corresponding thereto. In some embodiments, such output may further be merged or otherwise combined (e.g. in a netlist), used to generate polygon representations of objects in images, or the like.

In accordance with some of the embodiments described below, HRNet was used as an exemplary machine learning framework, wherein machine learning models were trained for 100 epochs with 21 high-resolution SEM images of seven (7) different types of ICs. The learning rate was decayed by a factor of 0.1 if a loss validation step stopped reducing over 2 epochs. Adam optimisation processes were employed with an initial learning rate of 0.001 and a weight decay of 10⁻⁸. With respect to wire segmentation, reported results relate to the evaluation of segmentation results from a dataset comprising 21 SEM images from the 7 training SEM IC images. With respect to embodiments related to via detection, further networks were employed as a feature extraction process. For example, various embodiments herein described relate to the employ of HRNet or ResNet to extract features, while a Faster R-CNN network was applied as an object detection network using features provided by HRNet or ResNet. Networks were trained for 150epochs with 100 high-resolution SEM images from eleven (11) different ICs. For such processes, stochastic gradient descent (SGD) optimisation was employed with an initial learning rate of 0.001, which was decayed by a factor of 10 for every 30 epochs, and with a momentum of 0.9 and a weight decay of 5×10⁻⁴. Evaluation of such processes as reported herein is with respect to a dataset comprising 20 high-resolution SEM images from the 11 IC images from training. However, it will be appreciated that such embodiments are presented for exemplary purposes, only, and that various other machine learning architectures, learning parameters, and evaluation metrics may be employed, and are hereby expressly contemplated, in accordance with different embodiments. For example, depending on particular needs of an object recognition application, different machine learning and/or CNN architectures may be employed. That is, depending on, for instance, the complexity of images, the object types to be recognised, or the like, one may employ machine learning processes or frameworks comprising different layers, depths, abstraction processes, or the like, or epoch numbers, momenta, weights, or the like, without departing from the general scope and nature of the disclosure.

In accordance with some embodiments, and as outlined above, various systems and processes as herein described relate to the recognition of IC features from SEM images. In some embodiments, this relates to the segmentation of wires and the detection of vias (and/or via locations) from image patches defined from an SEM image of an IC layer(s), using respective machine learning processes, models, and/or machine learning architectures. That is, a first machine learning process, architecture, and/or model may be employed to recognise object of a first type (e.g. to segment wires), and a second machine learning process, architecture, and/or model may be used to recognise objects of a second image type (e.g. to detect vias). However, it will be appreciated that the terms ‘first’ and ‘second’ are not to be construed as implying any form of required sequential order (e.g. that one need be performed another), but rather to distinguish between architectures, processes, or models. A first and a second architecture (and indeed any additional machine learning architectures) may be employed in any order, and/or in parallel. For instance, depending on a machine learning architecture employed, network configurations, and/or associated computational resources, two or more processes may be performed in parallel, or with the second process being performed before the first.

In some embodiments, wires may be segmented in accordance with a first machine learning architecture (e.g. an HRNet CNN architecture). SEM images may, in some of such embodiments, be first pre-processed to define image patches, as described above. For example, an SEM image of an IC may be divided into non-overlapping image patches of 256×256 pixels. For training, the first ML process may then downsample each input image patch to a feature map with ¼ of the original input size by two CNN layers with, for instance, a stride of 2. As high-level semantic features (i.e. the information carried by low-resolution feature maps) may, in accordance with some embodiments, not be critical for SEM image segmentation, the second CNN layer may have a modified stride (e.g. stride=1), such that the network extracts texture information from feature maps from higher resolution. For example, for an SEM patch size of 256×256 pixels, the first two CNN layers of the network may yield feature maps with a size of 128×128 pixels. These feature maps may be used to generate through interpolation (e.g. at the beginning of each stage) new feature maps with 1/2 the smallest feature map from the previous step. Blocks of a particular stage of a machine learning process may extract features of different resolution representations simultaneously, in accordance with some embodiments, wherein process blocks may contain, for instance, three layers, and wherein each layer is followed by a batch normalisation layer, and, in some embodiments, a ReLU activation layer. In yet further embodiments, a residual connection may be added in each process block for effective training.

In accordance with some embodiments, different process stages may comprise different numbers of framework blocks. For example, a third stage of a CNN network may comprise 12 CNN blocks, while a second stage may comprise 9 CNN blocks. However, depending on various application-specific parameters, different block numbers may be employed, in accordance with different embodiments.

Feature maps of different resolutions output from blocks may, in accordance with some embodiments, be merged at the end of each machine learning stage by, for instance, interpolation-based up- and downsampling. Output feature maps with the largest size from a previous stage may be up-sampled to the same size as the original input image, and may be fed as input to a subsequent recognition layer. In accordance with some embodiments, a final recognition layer may comprise a kernel with kernel=1 and stride=1. This layer may output, for instance, a binary segmentation result of the input SEM image patch. While various loss functions may be evaluated during training, one embodiment relates to the evaluation of a loss function for a wire segmentation model corresponding to a pixel-level binary class cross-entropy function related to the following expression, where y_{gt} corresponds to the ground truth label, and y_{pred} is the predicted label.

$${L}_{wire} ( {y}_{gt} , {y}_{pred} ) = - ( {y}_{gt} log ( {y}_{pred} ) + ( 1 - {y}_{gt} ) log ( 1 - {y}_{pred} ) )$$

As described above, various embodiments relate to the post-processing or refinement of output data from a machine learning process, architecture, and/or model. For example, with respect to the segmentation of wires from SEM images, it may be desirable for some applications to subject output from the model to a refinement process or refiner to, for instance, reduce or eliminate electrical significant differences (ESDs), to improve an aesthetic quality of the of a segmented output, or the like. As referred to herein, ESDs may comprise shorts or ‘opens’ that may alter an electrical function or connectivity from extracted circuits, such as through incorrectly segmented wires. It will be appreciated that other evaluation metrics may be employed, such as pixel-level classification accuracy and intersection-over-union (IoU). However, wrongly classified or segmented pixels may not necessarily result in shorts or opens in ICs, and thus may not necessarily impact an ESD metric.

In accordance with some embodiments, FIGS. 4A and 4B show illustrative outputs from a first image recognition process for recognising wires from an SEM image patch, wherein ESDs are observed from isolated wire pixels, and wherein opens A and B shown in boxes result from isolated pixels. In these examples, false positive (FP) wires correspond to pixels that were incorrectly labeled as wires in the prediction, while false negative (FN) wires correspond to pixels labeled incorrectly as background pixels in predictions. True positive (TP) wires correspond to pixels that are labeled correctly. In accordance with some embodiments, ESDs may be eliminated or reduced by merging isolated pixels into nearby wires, or by dropping the isolated pixels from consideration as a wire, using a refiner.

In accordance with some embodiments, a refiner or refinement process as herein described may comprise reclassifying pixels (e.g. each pixel) from a machine learning model output (e.g. a segmentation output) in accordance with recognition results of neighbouring pixels (e.g. segmentation values of neighbouring pixels), and/or a characteristic value thereof. Such processes may be executed using, for instance, a GPU or other processing resource, and may, in accordance with some embodiments, employ convolutional operations. For instance, while some embodiments relate to refining pixels based on various non-convolutional processes, some embodiments relate to a refiner comprising aspects represented by the following pseudocode in which convolutional principles are employed to refine pixel values based on a characteristic pixel value of pixels neighbouring a pixel to be refined. In one non-limiting example, for a pixel p, a kernel K selects k²−1 neighbours around p (e.g. k²−1 nearest neighbours to p). Elements of K are initialised with a value of 1, except for the centre element. As the values of pixels in, for instance, a segmentation result, are binary, a characteristic value of the neighbouring values, a non-limiting example of which may include a convolution thereof, may be equal to the number of, for instance, wire pixels around p. Accordingly, and in accordance with some embodiments, a threshold may be set, wherein p may be reclassified based on whether a characteristic pixel value and/or the convolution output is greater or less than the threshold. For example, if the output is greater than the threshold (k²−1)×t, the pixel p may be reclassified as a wire pixel. Conversely, if it is below the threshold, p may be reclassified as, for instance, background.

```
  Input: A h × w coarse wire segmentation result C[1...h, 1...w]
  Output: A h × w fine-grained wire segmentation result F[1...h,
```

1...w]

```
      Parameters: k - the size of convolution kernel K, where
    k = 2 × kᵣ + 1; t - the voting threshold, where t < k² − 1
```

| | |
|---|---|
| for i = 0 to k − 1 do: | [symbol] Initialize kernel K |

```
    for j = 0 to k − 1 do:
        K[i][j] = 1 if i != j else 0
for r = 0 to h do
    for c = 0 to w do
        if Σᵢ₌₋ₖ_{ᵣ}^{k}^{ᵣ} Σⱼ₌₋ₖ_{ᵣ}^{k}^{ᵣ} K[i + kᵣ][j + kᵣ] × C[r + i]][c + j] > t
then
          F[r][c] = 1
        else
          F[r][c] = 0
return F
```

In some embodiments, a refiner may be a standalone refiner, operable on, for instance, a segmented image to refine segmentation values of pixels thereof. In other embodiments, a refiner may be a component or element used in combination with other aspects of a system or apparatus related to the generation of a segmentation result. For example, a refiner of a system or apparatus may receive as input segmented output from a first machine learning model or process executed via a first machine learning architecture of the system or apparatus. Similarly, a refinement process may relate to a standalone refinement process, or may define one or more steps of a process. For example, one embodiment relates to a refinement process such as that described above performed in conjunction with image analysis steps producing segmented output from a machine learning model and/or process.

In accordance with some embodiments, a second machine learning process, model, network, and/or architecture may be employed in parallel with, prior to, or subsequently to the first machine learning process to recognise a second object type from an image. For some exemplary embodiments, this may relate to the recognition of vias from an SEM IC image (e.g. the same image from which the first machine learning process recognised wires) to ultimately establish a connectivity or relatively placement thereof. In accordance with various embodiments, the second machine learning architecture is distinct from the first machine learning process (e.g. uses a different CNN process(es), uses a distinct architecture or network, different layer configurations, parameter weights, a different network or model that is trained differently from the first network, and/or the like). This may be beneficial if, for instance, different object types are more usefully recognised in accordance with different processes (e.g. detection, segmentation, classification, or the like), or if different objects are preferably reported in different formats, manifest differently in a common image, and/or relate to metrics of value that application-specific. For example, by processing images to recognise a given object type in accordance with a designated machine learning architecture, a corresponding machine learning model may be robust for the recognition of the given object type, thereby improving reusability of the model for recognising the object type across images, thus reducing the time and cost associated with applications requiring the processing of many images (e.g. for industrial reverse engineering applications).

For example, and without limitation, while the example provided above with respect to output from a wire segmentation process being valuable if indicating accurate connectivity or continuity, such aspects may be less important for via detection, wherein an accurate reporting of via location may be relatively more valuable than, for instance, the size or shape of vias. Accordingly, one may employ distinct, well-tailored machine learning architecture or model to accurately extract the most relevant or valuable information based on the object type or the application at hand. Moreover, a second process may employ a different pre-processing aspect that that used by a first machine learning process, and/or employ different images or images patches. For example, and in accordance with various embodiments, while a first segmentation process may define non-overlapping image patches, a machine learning process for, for instance, detecting vias may pre-process an SEM to define overlapping image patches to, for instance, minimise false positives, or to employ designated refinement and/or post-processing steps to merge or otherwise combine results from image patches without excessive duplicates, false negatives, or false positives, in accordance with various embodiments.

With respect to one embodiment related to the detection of vias from an SEM image, a second machine learning process or architecture may comprise a similar framework to that of the first architecture described above. For example, a particular CNN network (e.g. HRNet) may be particular well suited to certain tasks, and/or be well developed and/or appropriate for a certain type of image (e.g. feature extraction from SEM images), and may thus be shared between distinct machine learning architectures. With respect to via detection from IC SEM images, and in accordance with one embodiment, a second machine learning architecture may thus comprise an HRNet framework similar to that described above with respect to wire segmentation. However, such a second architecture may comprise unique elements or models, be trained differently, and/or comprise different outputs, layers, and/or modules, as well as additional or substituted sub-processes.

For example, in contrast to the embodiment described above with respect to wire segmentation using HRNet, an embodiment directed towards via detection may comprise outputting feature maps, as well as one or more downsampled feature maps from the smallest feature maps of a previous stage, for input into a subsequent network (e.g. a region proposal network, or the like) to detect vias of different sizes. Moreover, and in accordance with some embodiments, additional processes may be applied during the process. In one embodiment, this may relate to the employ of a Faster R-CNN as a region proposal and object detection head. In contrast to conventional approaches, however, application-specific layers may be applied. For example, and in accordance with one embodiment, this may comprise substitution of an ROI pooling layer with an ROI alignment layer (e.g. that proposed by Mask R-CNN), since an ROI alignment layer may sample a proposed region from feature maps more accurately using interpolation techniques. In yet further embodiments, such a second ML process may comprise the employ of various object detection pipelines, such as that utilised by ResNet, as a feature extraction framework.

As noted above with respect to a first ML process, training a second ML model generation process may also relate to the evaluation of various loss functions. However, one embodiment comprises evaluation of a loss function of the following form, where Lᵣₚₙ is the loss of the region proposal network in Faster R-CNN, and L_{box} is the bounding box regression loss.

Lᵥᵢₐ=L_{rpb}+L_{box}

In accordance with various embodiments, output from a second machine learning architecture or model may undergo a refinement process. Depending on, for instance, the nature of the objects identified, a refiner may be similar to that described above with respect to a first refinement process for, for instance, segmentation output, or may comprise different elements or processes. For instance, and in accordance with some embodiments, a second machine learning model may output a list of predicted boxes and associated confidence scores corresponding to objects (e.g. vias) detected from images. Objects having associated therewith a confidence score may first be discarded (e.g. vias associated with a confidence score<0.6). Those with a sufficient confidence score, however, may serve as a final output from a recognition process.

As described above, features detected within a designated border region (e.g. border 312) of an image or image patch may also be discarded during a refinement process. For example, via ‘boxes’ detected within 50 pixels of an image edge (or other suitable border 312) may be discarded to remove incomplete edge vias or detected ‘via-like’ objects. A refinement process may further comprise various additional steps. For example, if a predicted via ‘box’ is completely within a border region, it may be considered as the equivalent of a feature detected with a low confidence score (e.g. <0.6 or another suitable threshold), and may thus be discarded.

A refinement process may additionally or alternatively comprise a refinement merging process. For example, and in accordance with some embodiments, via detection tasks may relate to the definition of overlapping image patches from an SEM image. In such cases, object predictions in overlapping regions may receive further consideration. In one embodiment, a refiner may then detect overlapped predictions (e.g. overlapping ‘boxes’ corresponding to via predictions) in neighbouring patches, wherein a degree of overlap is considered to estimate whether or not via predictions are different vias, or indeed the same via detected in two images from common subject matter. For example, and in accordance with one embodiment, a refiner may compare an intersection-over-union (IoU) of two predictions with a threshold value (e.g. 30% overlapping). If the intersection is greater than the threshold, the predictions may be considered to be the same object, and the prediction with the highest confidence score may be kept, while the other is discarded. This may, for instance, reduce false positives, in accordance with some embodiments. It will be appreciated that other logic or like steps may be automatically employed for refinement, in accordance with various embodiments.

With reference to the abovementioned first and second machine learning processes or architectures for performing respective recognition processes of first and second object types (i.e. wire segmentation and via detection, respectively), the following description relates to an evaluation of the performance of one embodiment of the described systems and methods. However, it will be appreciated that such processes and systems are provided for exemplary purposes, only, and that various other processes or systems may be employed for similar or different object types and/or applications, in accordance with various embodiments. For example, and without limitation, while HRNet-3 was employed as a machine learning backbone for both machine learning architectures outlined above, HRNet-4 or HRNet-5 (having different numbers stages from HRNet-3) may be employed for, for instance, different IC SEM image complexities or recognition challenges, feature distributions or types, or the like. Similarly, different machine learning architectures or processes may be employed and/or trained depending on, for instance, the objects to be detected, such as natural objects, in accordance with other embodiments.

As described above, first and second machine learning models may be trained with selected and/or augmented training data. However, various embodiments relate to methods and systems for recognising different objects in images using previously trained machine learning recognition models. Accordingly, while the following embodiment relates to the use of machine learning platforms trained in accordance with the exemplary aspects described above, it will be appreciated that similarly or differently trained respective machine learning models may be equally applied to recognise each of a plurality of object types.

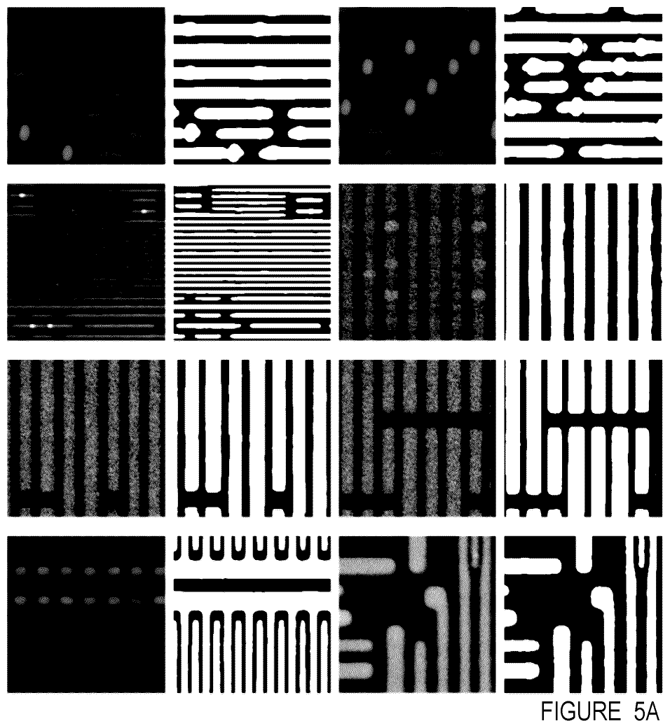

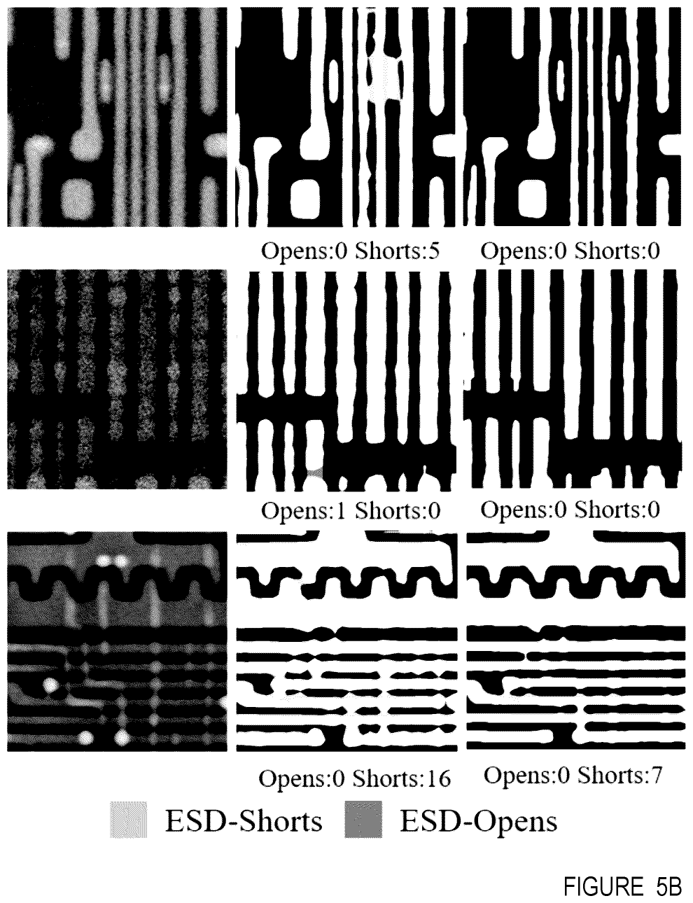

Visualisation of the segmentation of wires from SEM image patches (i.e. visualisation of datasets output from a first machine learning recognition model recognising a first object type) is presented in FIG. 5A. In this example, segmentation outputs are shown in the right panel of every pair of corresponding images (i.e. the second and fourth columns from the left), wherein background is shown as black, and wires are labeled as white. In this case, and in accordance with various embodiments, the first machine learning recognition model does not distinguish between wires and vias. That is, both vias and wires in the SEM image (image to the left in each image pair, i.e. the first and third columns from the left) are labeled in the segmentation output as the same segmentation value (e.g. 1). This aspect (i.e. both wires and vias having the same segmentation value) may allow for, for instance, the improvement of wire predictions, in accordance with some embodiments, by, for instance, minimising reliance on intensity thresholds to segment vias from wires, which challenges conventional approaches.

FIG. 5B shows further examples of wire segmentation results, in accordance with one embodiment. In this example, reported ESD statistics correspond to the entire SEM 1920×1080 image from which the exemplary image patches shown are defined. The left-most column of image patches corresponds to SEM image patches, the middle column corresponds to image patches processed in accordance with a segmentation process adapted from Lin et al., and the rightmost column corresponds to output obtained with a first machine learning-based model trained as described herein.

Such output results may, in accordance with some embodiments, be quantitatively evaluated. For example, Table 1 summarises the results of two machine learning recognition models for recognising a first object type corresponding to the segmentation of wires from SEM images, in accordance with some embodiments. In this case, two different machine learning frameworks (HRNet-3 and HRNet-4), each having been tested as exemplary first machine learning recognition frameworks, are compared with a reference process adapted from that proposed by Lin, et al.

TABLE 1
Wire Segmentation Results

| Models | Avg ACC | Avg IoU | Avg ESD |
|---|---|---|---|
| FCN with VGG16 | 94.40 [symbol] | 89.32 [symbol] | 329.86 |
| HRNet-3 | 95.75 [symbol] | 91.86 [symbol] | 50.71 |
| HRNet-4 | 95.71 [symbol] | 91.78 [symbol] | 69.77 |

[symbol]

indicates data missing or illegible when filed

In this example, one difference between the two HRNet models for the first machine learning architecture is the number of stages employed in the platform. Although the pixel-level classification accuracy and IoU results of both trained models are similar, the performance gap in average ESD is larger, corresponding to segmented pixels causing different amounts of shorts or opens in the circuits extracted from segmentation. Accordingly, depending on the needs of the particular application, a performance standard, computational requirements or access, or the object type to be recognised, a user may employ a preferred architecture for a first machine learning recognition process. For example, any of the models described by Table 1 may be employed as a first machine learning architecture for recognising objects of a first type, but a user unfettered by computational limitations may select for a wire segmentation process the HRNet-3-based model, as it produces the least amount of ESDs.

In accordance with some embodiments, Table 2 shows exemplary results of the refinement process described above (i.e. a convolutional k-NN refiner) applied to a wire segmentation from SEM IC images. That is, a neighbouring pixel-based convolutional refiner was applied to coarse segmentation results generated by CNN networks. In this example, k=7 and t=0.5, and ESDs were reduced by 15.6% from coarse segmentation results. In accordance with another embodiment, selection of k=7 and t=0.75 effectively reduced ESDs in segmentation results generated using HRNet-3. This latter example exhibits a reduction of ESDs for every circuit, highlighting that, in accordance with various embodiments, a refiner as herein described enables highly reliable automatic recognition of an object type without requiring the hand-tuning of parameters for recognition processes (e.g. hand-tuning the kernel size or a threshold). Further, this relates to a robust model that is reusable across images. In the non-limiting example of Table 2, RR refers to a reduce rate as a percentage of the ESDs reduced by a refinement process as herein described.

TABLE 2
Neighbor Pixel Refiner Results for Wire Segmentation

| Models | ESD w/o refiner | ESD w/refiner | RR |
|---|---|---|---|
| HRNet-3 k = 7; t = 24 | 66.38 | 55.9 | 15.79% |
| HRNet-3 k = 9; t = 40 | 66.38 | 55.71 | 16.07% |
| HRNet-3 k = 7; t = 36 | 66.38 | 50.71 | 23.61% |
| HRNet-4 k = 7; t = 24 | 82.67 | 69.77 | 15.60% |
| HRNet-4 k = 9; t = 40 | 82.67 | 69.86 | 15.50% |

Input images comprising SEM IC images may comprise a large amount of relatively constant-texture components that are relatively sparse in the frequency domain. Accordingly, various embodiments may additionally or alternatively relate to the application of a frequency-domain machine learning process or model. That is, a distinct machine learning model (e.g. a first, second, or third machine learning model employed, in accordance with various embodiments) may incorporate one or more frequency-domain processes to, for instance, output a dataset representative of an object or type thereof that is recognised. For instance, some embodiments relate to the combination of such a process with HRNet to ultimately recognise objects. In accordance with one embodiment, an HRNet-based process as described above may be combined with a frequency-domain process such as that disclosed in Xu, et al. (Kai Xu, Minghai Qin, Fei Sun, Yuhao Wang, Yen-Kuang Chen, and Fengbo Ren, ‘Learning in the Frequency Domain’. IEEE CVF Conference on Computer Vision and Pattern Recognition (CVPR), 1737-1746, DOI: 10.1109/CVPR42600.2020.00181, 2020).

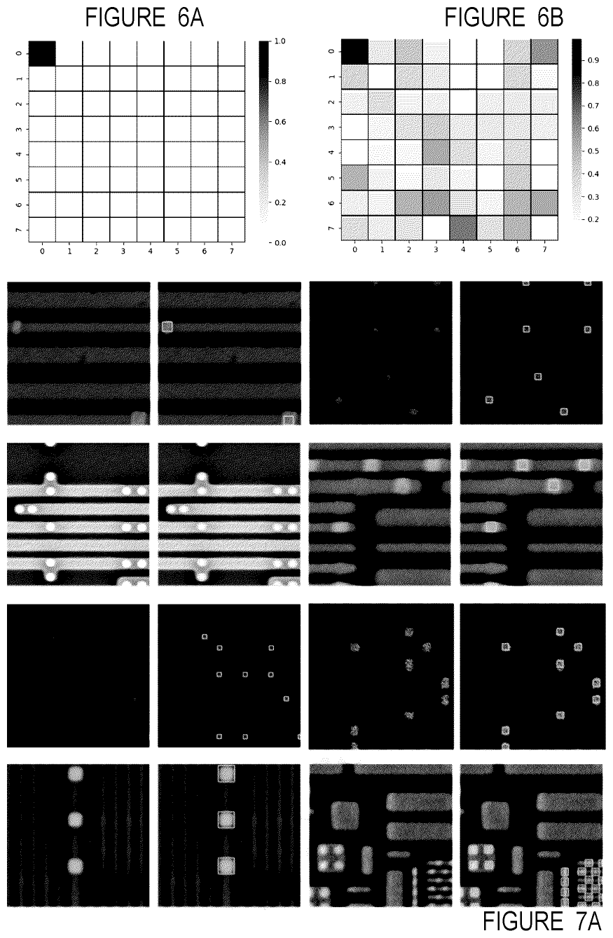

In accordance with this non-limiting embodiment, the frequency-domain learning may reveal a spectral bias in, for instance, an SEM image wire segmentation, wherein the frequency-domain process performs, for example, 2D discreet cosine transforms (DCT) on, for instance, 8×8 blocks. The transformed image may thus, in the frequency domain, comprise a size corresponding to 64×h/8×w/8, where h is the height and w is the width of the image in the spatial domain. With the help of the frequency channel, and in accordance with one embodiment, the dynamic selection module proposed by, for instance, Xu, et al., the spectral bias of a machine learning process (e.g. HRNet) for a recognition task (e.g. wire segmentation) may be achieved. An exemplary result is shown in FIG. 6A, wherein it is shown that only the DC frequency channel has over 99% probability to be activated for a given type of image (e.g. IC SEM images with respect to wires). Such a result may indicate, in accordance with some embodiments, that only a particular channel, or certain frequency channels, contains information of relevance for a particular recognition task (e.g. wire recognition). Further, and in accordance with some embodiments, a process may employ only such channels deemed important for recognition as inputs for model training, testing, and/or recognition, thus improving process flow and/or efficiency. Exemplary results associated with such a methodology are presented in Table 3. In this example, compared to a machine learning process considering all frequencies (i.e. HRNet-3), the model trained with only the DC frequency channel achieves higher pixel-level accuracy and IoU, indicating that removing ‘noisy’ information in other frequency channels may improve the performance of pixel classification, segmentation, or other form of recognition, depending on the application at hand.

TABLE 3
Frequency-domain Learning Results with IIRNet-3

| Models | Avg ACC | Avg IoU | Avg ESD |
|---|---|---|---|
| HRNet-3 | 95.75 [symbol] | 91.86 [symbol] | 66.38 |
| HRNet-3 DC | 96.04 [symbol] | 92.39 [symbol] | 127.33 |

[symbol]

indicates data missing or illegible when filed

With respect to, for instance, via recognition, various metrics may be employed to evaluate performance of machine learning processes or models, in accordance with various embodiments. In accordance with one exemplary embodiment, precision and recall may be evaluated. In such a case, matches between predicted boxes and ground truth boxes associated with vias may be found by computing the IoU of every pair of predicted boxes and ground truth boxes. In such an embodiment, if a predicted box has an IoU with any ground truth boxes that is greater than a designated threshold (e.g. >0.3), then the box may be considered to be a correctly detected via, referred to herein as a true positive (TP) case. In accordance with one embodiment, a ground truth box may only have one matched predicted box (e.g. that with the largest IoU). Conversely, a predicted box without a matched ground truth box during training may be considered as a false positive (FP) case, while a ground truth box without a matched predicted box may be considered as a false negative (FN) case.

In accordance with some embodiments, precision and recall, as referred to herein, may be described as, respectively, the following, wherein precision evaluates the error rate in predictions of various proposed methods and/or systems, and recall evaluates the detection rate for various objects (e.g. vias):

$$precision = \frac{TP}{TP + FP} , and \\ recall = \frac{TP}{TP + FN} .$$

With respect to a second machine learning recognition process or model, various embodiments relate to the detection of vias from SEM images, exemplary results of which are presented in Table 4. In this example, HRNet-4 was employed, wherein feature maps were downsampled with the smallest size in a latest stage using interpolation to generate feature maps with five different resolutions as input features for a Faster R-CNN process. With respect to HRNet-5 results, all outputs from the last stage were used as input features for a subsequent Faster R-CNN. In these embodiments, the via detection model with HRNet-5 achieved 99.77% precision, and the model with ResNet obtained 98.56% recall. In comparison with the framework adapted from Lin, et al., and in accordance with various embodiments, precision, recall, and F1 metrics are improved using various of the alternative proposed frameworks. While the models and frameworks described in Table 4 relate to various architectures for recognising, for instance, a second object type, it will be appreciated that various of other models, frameworks, or architectures may be employed, in accordance with different embodiments. However, it will be appreciated that some embodiments relate to the selection of a model or architecture related thereto that is well suited to the task at hand. For example, if a second object type relates to the recognition of vias, a user may, in accordance with some embodiments, select a ML model or architecture for performing ML-based detection, rather than ML-based segmentation, as such models may have improved robustness for application with different images (i.e. have reusability).

TABLE 4
Via Detection Results

| Models | Precision | Recall | F1 |
|---|---|---|---|
| FCN with VGG16 | 93.44 [symbol] | 89.35 [symbol] | 91.35 [symbol] |
| HRNet 4 | 99.72 [symbol] | 98.38 [symbol] | 99.05 [symbol] |
| HRNet 5 | 99.77 [symbol] | 98.23 [symbol] | 98.99 [symbol] |
| ResNet | 98.88 [symbol] | 98.56 [symbol] | 98.72 [symbol] |

[symbol]

indicates data missing or illegible when filed

To further evaluate various aspects of the proposed systems and methods, and in accordance with some embodiments, the impact of generating overlapping patches for object recognition (e.g. via detection) may be evaluated. For example, Table 5 presents the impact of generating overlapping patches for via detection inference. In this example, a model inference with overlapping patches achieved a 5.47% precision improvement and a 3.72% recall improvement, corresponding to the removal of predictions in a border area (e.g. border 312) reducing the number of incorrectly detected ‘via-like’ objects, while maintaining a robustness of the model inference, in accordance with some embodiments.

TABLE 5
Via Detection Results of the model inference
w/ and w/o overlapping SEM patches

| Models | Precision | Recall | F1 |
|---|---|---|---|
| HRNet 4 w/ overlapping patches | 99.77 [symbol] | 98.34 [symbol] | 99.05 [symbol] |
| HRNet 4 w/o overlapping patches | 94.40 [symbol] | 94.62 [symbol] | 94.51 [symbol] |

[symbol]

indicates data missing or illegible when filed

As described above with respect to a first machine learning process or model, a second machine learning process or model may be similarly be analysed with respect to frequency-domain learning for the detection of a second object type. As one non-limiting example, the extracted spectral bias for via detection is shown in FIG. 6B. In this case, compared to the spectral bias of wire segmentation under similar conditions, more frequency channels have over 50% probability of being activated by a sample. However, the DC frequency channel maintains the highest probability of being selected. Keeping only the DC channel frequency, in this case, corresponds to the application of block-wise average filtering of images in the spectral domain. Processing, for instance, SEM images as such may thus result in the performance reported in Table 6, in accordance with some embodiments. In this case, the detection precision of trained models with block-wise average filtering inputs is improved, but the detection recall is decreased compared to the trained models with other inputs. Generally, however, models trained with conventional inputs may be similar, thus highlighting, in consideration of the spectral and temporal aspects of a first segmentation process above, an object-type association with machine learning process selection, in accordance with various embodiments.

TABLE 6
Via Detection Results with Block-wise Average Filtering Inputs

| Models | Precision | Recall | F1 |
|---|---|---|---|
| HRNet 4 | 99.77 [symbol] | 98.34 [symbol] | 99.05 [symbol] |
| ResNet | 99.72 [symbol] | 98.38 [symbol] | 99.05 [symbol] |

[symbol]

indicates data missing or illegible when filed

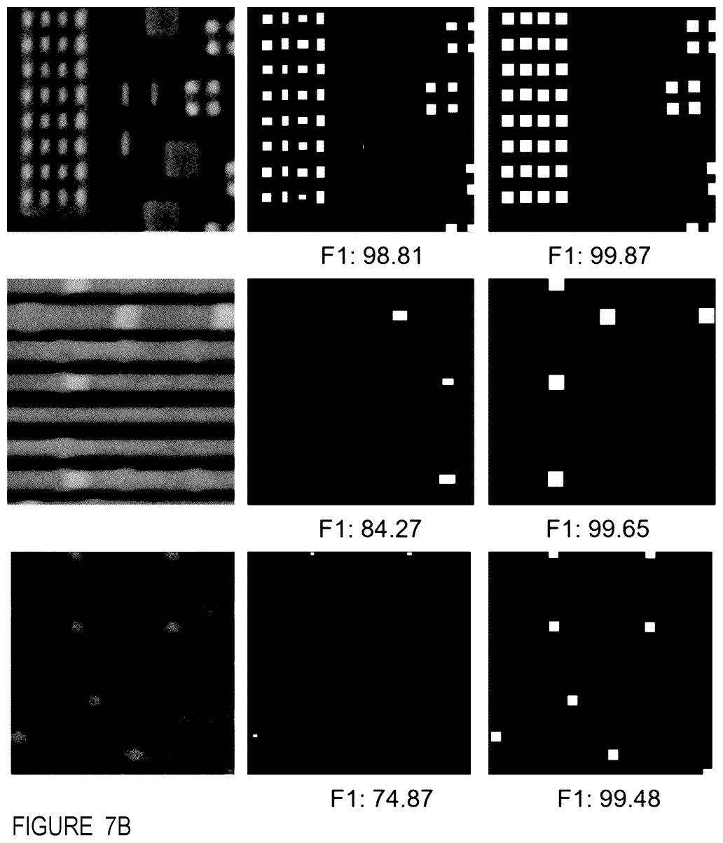

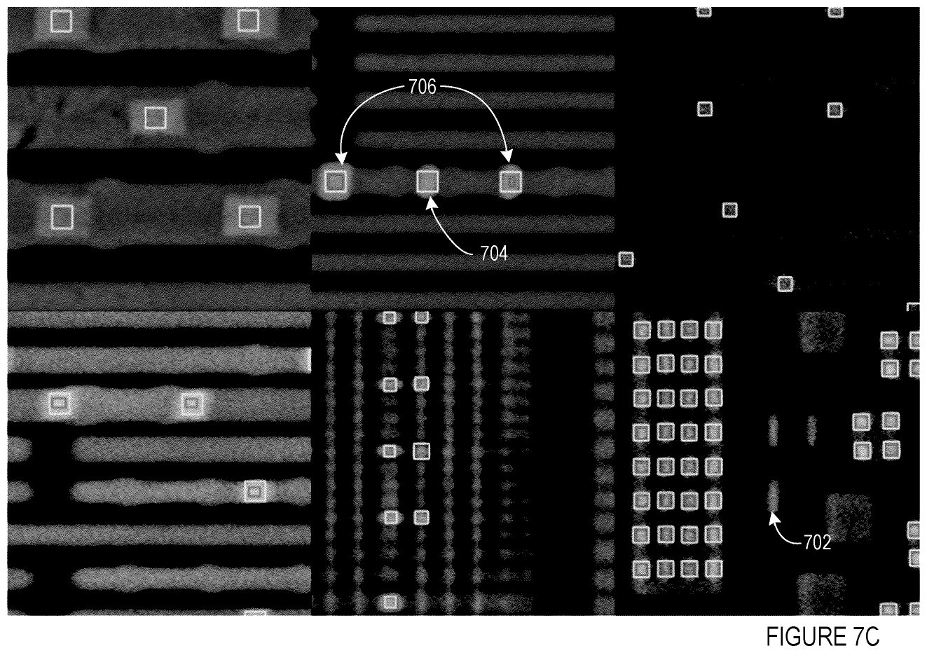

In accordance with some embodiments, output from a second recognition processes for detecting vias from SEM images of an IC is shown in FIG. 7A. In this case, boxes indicating predicted vias are labeled in the images. FIG. 7B shows further examples of via detection results, in accordance with another embodiment. In this example, the left-most column of image patches corresponds to SEM image patches, the middle column corresponds to image patches processed in accordance with the adapted process described by Lin, et al. (i.e. one that is not object-type specific not reusable) wherein vias are segmented as irregularly shaped and irregularly sized objects. In this example, the rightmost column corresponds to regularly sized and shaped via output datasets generated using a second machine learning-based model trained as described herein, in accordance with various embodiments. FIG. 7C shows similar examples, wherein six SEM image patches are shows with via detection results overlaid thereon. In these examples, dark rectangles (e.g. rectangle 702) correspond to irregularly shaped vias detected using a process as described by Lin, et al., while lighter squares (e.g. square 704) correspond to via predictions made by a reusable ML model, as herein described. In this example, while some vias are detected by both methods (e.g. vias 706 indicated by both dark rectangles and light squares), the reusable object-specific model outperforms the model by Lin, in accordance with various embodiments.

It will be appreciated that various forms of output may be produced, in accordance with different embodiments. For example, predicted vias may be output as a list of via positions. Further, such output may be combined with, for instance, output from the first recognition process. In one embodiment, image patches, or datasets recognised therefrom (e.g. segmented wires and detected vias) are recombined to form the original input image, including predicted labels (e.g. labels retained after post-processing or refinement). In another embodiment, datasets indicative of circuit features may be combined, formatted, and/or interpreted to generate an electrical circuit representation for future reference. In yet another embodiment, the data output from respective recognition processes may be used to automatically generate a netlist of circuit features.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. An image analysis method for recognising each of a plurality of object types in an image, the method to be executed by at least one digital data processor in communication with a digital data storage medium having the image stored thereon, the method comprising:
accessing a digital representation of at least a portion of the image;
by a first reusable recognition model associated with a first machine learning architecture, recognising objects of a first object type of the plurality of object types in the digital representation;
by a second reusable recognition model associated with a second machine learning architecture, recognising objects of a second object type of the plurality of object types in the digital representation;
outputting respective first and second object datasets representative of objects of said first and second object types in the digital representation of the image.

2. The method of claim 1, wherein one or more of said first or second reusable recognition model comprises a segmentation model or an object detection model.

3. The method of claim 2, wherein said first reusable recognition model comprises a segmentation model and said second reusable recognition model comprises an object detection model.

4. The method of any one of claims 1 to 3, wherein one or more of said first or second reusable recognition model comprises a user-tuned parameter-free recognition model.

5. The method of any one of claims 1 to 4, wherein one or more of said first or second reusable recognition model comprises a generic recognition model.

6. The method of any one of claims 1 to 5, wherein one or more of said first or second reusable recognition model comprises a convolutional neural network recognition model.

7. The method of any one of claims 1 to 6, wherein said first object type and said second object type correspond to different object types.

8. The method of any one of claims 1 to 7, further comprising training one or more of said first or second reusable recognition model with context-specific training images or digital representations thereof.

9. The method of any one of claims 1 to 8, wherein the digital representation comprises each of a plurality of image patches corresponding to respective regions of the image.

10. The method of claim 9 further comprising defining said plurality of image patches.

11. The method of claim 10, wherein said images patches are defined to comprise partially overlapping patch regions.

12. The method of claim 11, further comprising refining output of objects recognised in said overlapping regions.

13. The method of claim 12, wherein said refining comprises performing an object merging process.

14. The method of any one of claims 9 to 13, wherein said plurality of image patches is differently defined for said recognising objects of a first object type and said recognising objects of a second object type.

15. The method of any one of claims 9 to 14, wherein, for at least some of said image patches, one or more of said recognising objects of said first object type or said recognising objects of said second object type is performed in parallel.

16. The method of any one of claims 1 to 15, further comprising post-processing at least some of said objects in accordance with a refinement process.

17. The method of claim 16, wherein said refinement process comprises a convolutional refinement process.

18. The method of either one of claim 16 or claim 17, wherein said refinement process comprises a k-nearest neighbours (k-NN) refinement process.

19. The method of any one of claims 1 to 18, wherein one or more of said first or second object dataset comprises one or more of an image segmentation output or an object location output.

20. The method of any one of claims 1 to 19, wherein the method is automatically implemented by said at least one digital data processor.

21. The method of any one of claims 1 to 20, wherein the image is representative of an integrated circuit (IC).

22. The method of claim 21, wherein one or more of said first or second object type comprises a wire, a via, a polysilicon area, a contact, or a diffusion area.

23. The method of any one of claims 1 to 22, wherein the image comprises an electron microscopy image.

24. The method of any one of claims 1 to 23, wherein the image is representative of a respective region of a substrate and the method further comprises repeating the method for each of a plurality of images representative of respective regions of said substrate.

25. The method of any one of claims 1 to 24, further comprising combining the first and second object datasets into a combined dataset representative of the image.

26. The method of any one of claims 1 to 25, further comprising digitally rendering an object-identifying image in accordance with one or more of said first and second object datasets.

27. The method of any one of claims 1 to 26, further comprising independently training said first and second reusable recognition models.

28. The method of any one of claims 1 to 27, further comprising training said first and second reusable recognition models with training images augmented with application-specific transformations.

29. The method of claim 28, wherein said application-specific transformations comprise one or more of an image reflection, rotation, shift, skew, pixel intensity adjustment, or noise addition.

30. An image analysis method for recognising each of a plurality of object types of interest in an image, the method to be executed by at least one digital data processor in communication with a digital data storage medium having the image stored thereon, the method comprising:
accessing a digital representation of the image;
for each object type of interest, recognising each object of interest in the digital representation by a corresponding reusable object recognition model associated with a corresponding respective machine learning architecture;
outputting respective object datasets representative of respective objects of interest corresponding to each object type of interest in the digital representation of the image.

31. A method for digitally refining a digital representation of a segmented image defined by a plurality of pixels each having corresponding pixel value, the method to be digitally executed by at least one digital data processor in communication with a digital data storage medium having the digital representation stored thereon, the method comprising:
for each refinement pixel to be refined, calculating a characteristic pixel value corresponding to the pixel values of a designated number of neighbouring pixels;
digitally comparing said characteristic pixel value with a designated threshold value; and
upon said characteristic pixel value satisfying a comparison condition with respect to said designated threshold value, assigning a refined pixel value to said refinement pixel.

32. The method of claim 31, wherein said calculating a characteristic pixel value comprises performing a digital convolution process.

33. The method of either one of claim 31 or claim 32, wherein the segmented image is representative of an integrated circuit.

34. The method of any one of claims 31 to 33, wherein the digital representation corresponds to output of a machine learning-based image segmentation process.

35. An image analysis method for recognising each of a plurality of circuit feature types in an image of an integrated circuit (IC), the method to be executed by at least one digital data processor in communication with a digital data storage medium having the image stored thereon, the method comprising:
for each designated feature type of the plurality of circuit feature types:
digitally defining a feature type-specific digital representation of the image;
by a reusable feature type-specific object recognition model associated with a corresponding machine learning architecture, recognising objects of said designated feature type in said type-specific digital representation; and
digitally refining in accordance with a feature type-specific refinement process output from said feature type-specific object recognition process.

36. An image analysis system for recognising each of a plurality of object types in an image, the system comprising:
at least one digital data processor in network communication with a digital data storage medium having the image stored thereon, the at least one digital data processor configured to execute machine-executable instructions to:
access a digital representation of at least a portion of the image;
by a first reusable recognition model associated with a first machine learning architecture, recognise objects of a first object type of the plurality of object types in the digital representation;
by a second reusable recognition model associated with a second machine learning architecture, recognise objects of a second object type of the plurality of object types in the digital representation;
output respective first and second object datasets representative of objects of said first and second object types in the digital representation of the image.

37. The image analysis system of claim 36, wherein one or more of said first or second reusable recognition model comprises a segmentation model or an object detection model.

38. The image analysis system of claim 37, wherein said first reusable recognition model comprises a segmentation model and said second reusable recognition model comprises an object detection model.

39. The image analysis system of any one of claims 36 to 38, wherein one or more of said first or second reusable recognition model comprises a user-tuned parameter-free recognition model.

40. The image analysis system of any one of claims 36 to 39, wherein one or more of said first or second reusable recognition model comprises a convolutional neural network recognition model.

41. The image analysis system of any one of claims 36 to 40, further comprising a non-transitory machine-readable storage medium having said first and second reusable recognition models stored thereon.

42. The image analysis system of any one of claims 36 to 41, wherein the machine-executable instructions further comprise instructions to define each of a plurality of image patches corresponding to respective regions of the image.

43. The image analysis system of claim 42, wherein said images patches comprise partially overlapping patch regions.

44.

43. e analysis system of claim 43, wherein the machine-executable instructions further comprise instructions to refine output of objects recognised in said overlapping regions.

45. The image analysis system of claim 44, wherein the machine-executable instructions to refine output correspond to performing an object merging process.

46. The image analysis system of any one of claims 42 to 45, wherein said plurality of image patches is differently defined for recognising objects of said first object type and recognising objects of said second object type.

47. The image analysis system of any one of claims 36 to 46, wherein the machine-executable instructions further comprise instructions to post-process at least some of said objects in accordance with a refinement process.

48. The image analysis system of claim 47, wherein said refinement process comprises a convolutional refinement process.

49. The image analysis system of either one of claim 47 or claim 48, wherein said refinement process comprises a k-nearest neighbours (k-NN) refinement process.

50. The image analysis system of any one of claims 36 to 49, wherein one or more of said first or second object dataset comprises one or more of an image segmentation output or an object location output.

51. The image analysis system of any one of claims 36 to 50, wherein the image is representative of an integrated circuit (IC).

52. The image analysis system of claim 51, wherein one or more of said first or second object type comprises a wire, a via, a polysilicon area, a contact, or a diffusion area.

53. The image analysis system of any one of claims 36 to 52, wherein the image comprises an electron microscopy image.

54. The image analysis system of any one of claims 36 to 53, wherein the image is representative of a respective region of a substrate and the machine-executable instructions further comprise instructions for repeating the machine-executable instructions for each of a plurality of images representative of respective regions of said substrate.

55. The image analysis system of any one of claims 36 to 54, wherein the machine-executable instructions further comprise instructions to combine the first and second object datasets into a combined dataset representative of the image.

56. The image analysis system of any one of claims 36 to 55, wherein the machine-executable instructions further comprise instructions to digitally renderer an object-identifying image in accordance with one or more of said first and second object datasets.

57. The image analysis system of any one of claims 36 to 56, wherein said first and second reusable recognition models are trained with training images augmented with application-specific transformations.

58. The image analysis system of claim 28, wherein said application-specific transformations comprise one or more of an image reflection, rotation, shift, skew, pixel intensity adjustment, or noise addition.

59. An image analysis system for recognising each of a plurality of object types of interest in an image, the system comprising:
a digital data processor operable to execute object recognition instructions;
at least one digital image database comprising the image to be analysed for the plurality of object types, the at least one digital image database being accessible to the digital data processor;
a digital storage medium having stored thereon, for each of the plurality of object types, a distinct corresponding reusable recognition model deployable by the digital data processor and associated with a corresponding distinct machine learning architecture; and
a non-transitory computer-readable medium comprising the object recognition instructions which, when executed by the digital data processor, are operable to, for each designated type of the plurality of object types of interest:
access a digital representation of at least a portion of the image from the at least one digital image database;
recognise at least one object of the designated type in the digital representation by deploying the distinct corresponding reusable recognition model;
output a respective object dataset representative of objects of said designated type in the digital representation of the image.

60. The image analysis system of claim 59, further comprising a digital output storage medium accessible to the digital data processor for storing each said respective object dataset corresponding to each said designated type of the plurality of object types of interest.

61. The image analysis system of either one of claim 59 or claim 60, wherein the digital data processor is operable to repeatably execute said object recognition instructions for a plurality of images.

62. The images analysis system of claim 61, wherein each distinct corresponding reusable recognition model is configured to be repeatably applied to said plurality of images.

63. An image analysis system for digitally refining a digital representation of a segmented image defined by a plurality of pixels each having corresponding pixel value, the system comprising:
at least one digital data processor in communication with a digital data storage medium having the digital representation stored thereon, the at least one digital data processor further in communication with a non-transitory computer-readable storage medium having digital instructions stored thereon which, upon execution, cause the at least one digital data processor to:
for each refinement pixel to be refined, calculate a characteristic pixel value corresponding to the pixel values of a designated number of neighbouring pixels;
digitally compare said characteristic pixel value with a designated threshold value; and
upon said characteristic pixel value satisfying a comparison condition with respect to said designated threshold value, assign a refined pixel value to said refinement pixel.

64. The image analysis system of claim 63, wherein said characteristic pixel value is calculated in accordance with a digital convolution process.

65. The image analysis system of either one of claim 63 or claim 64, wherein the segmented image is representative of an integrated circuit.

66. The image analysis system of any one of claims 63 to 65, wherein the digital representation corresponds to output of a machine learning-based image segmentation process.

67. An image analysis system for recognising each of a plurality of circuit feature types in an image of an integrated circuit (IC), the system comprising:
at least one digital data processor in communication with a digital data storage medium having the image stored thereon, the at least one digital data processor further in communication with a non-transitory computer-readable storage medium having digital instructions stored thereon which, upon execution, cause the at least one digital data processor to, for each designated feature type of the plurality of circuit feature types:
digitally define a feature type-specific digital representation of the image;
by a reusable feature type-specific object recognition model associated with a corresponding machine learning architecture, recognise objects of said designated feature type in said type-specific digital representation; and
digitally refine in accordance with a feature type-specific refinement process output from said feature type-specific object recognition process.

68. The image analysis system of claim 67, wherein said non-transitory computer-readable storage medium has stored thereon each of said reusable feature-type specific object recognition models.

69. A non-transitory computer-readable storage medium having stored thereon digital instructions which upon execution by at least digital data processor cause the at least one digital data processor to, for each of a plurality of circuit feature types:
digitally define a feature type-specific digital representation of the image;
by a reusable feature type-specific object recognition model associated with a corresponding machine learning architecture, recognise objects of said designated feature type in said type-specific digital representation; and
digitally refine output from said feature type-specific object recognition process in accordance with a feature type-specific refinement process.

70. The non-transitory computer-readable storage medium of claim 69, having further stored thereon each of said reusable feature-type specific object recognition models.

71. A non-transitory computer-readable storage medium having stored thereon digital instructions which upon execution by at least digital data processor cause the at least one digital data processor to:
access a digital representation of at least a portion of the image;
by a first reusable recognition model associated with a first machine learning architecture, recognise objects of a first object type of the plurality of object types in the digital representation;
by a second reusable recognition model associated with a second machine learning architecture, recognise objects of a second object type of the plurality of object types in the digital representation;
output respective first and second object datasets representative of objects of said first and second object types in the digital representation of the image.

72. The non-transitory computer-readable storage medium of claim 69, having further stored thereon each of said reusable feature-type specific object recognition models.

73. A non-transitory computer-readable storage medium having stored thereon digital instructions for digitally refining a digital representation of a segmented image defined by a plurality of pixels each having corresponding pixel value, the digital instructions which upon execution by at least digital data processor cause the at least one digital data processor to:
for each refinement pixel to be refined, calculate a characteristic pixel value corresponding to the pixel values of a designated number of neighbouring pixels;
digitally compare said characteristic pixel value with a designated threshold value; and
upon said characteristic pixel value satisfying a comparison condition with respect to said designated threshold value, assign a refined pixel value to said refinement pixel.
